(19) United States
(12) Patent Application Publication
(10) Pub. No.: US 2017/0152990 A1
(43) Pub. Date: Jun. 1, 2017

(54) Wearable Body Supported Computer

(71) Applicant: Peter Johann Kielland, Ottawa (CA)

(72) Inventor: Peter Johann Kielland, Ottawa (CA)

(21) Appl. No.: 15/361,687

(22) Filed: Nov. 28, 2016

(30) Foreign Application Priority Data
Nov. 26, 2015 (CA) 2913369

(51) Int. Cl. F16M 13/04; G03B 17/56; F16M 11/06; G06F 1/16; A45F 5/00; B60R 11/02

(52) U.S. Cl. CPC F16M 13/04; A45F 5/00; B60R 11/0252; B60R 11/0211; F16M 11/06; G06F 1/163; G06F 1/1643; G06F 1/1626; G06F 1/1669; G06F 1/1681; G03B 17/561; B60R 2011/0005

(57) ABSTRACT

A wearable portable computer body support is combined with a camera carried by the support preferably pointed at an angle directed below the plane of the computer touchscreen. A stereoscopic viewer provides a user with a stereoscopic viewing experience when stereo images are presented on the viewing screen of the supported computer. The lengths of the neck strap on either side of the user are adjustable so as to permit bring the computer from a deployed location at the waist of the user up to a position close to the face of a user to provide the user with a stereoscopic viewing experience. A hat-worn light-cloaking apparatus may be provided to shade the computer in brightly lit conditions.

### FIELD OF THE INVENTION

This invention relates to improvements for use with a wearable portable computer support. In one variant it relates to an arrangement whereby a camera may be mounted to a portable computer which is configured to be wearable. In another variant it relates to an arrangement whereby a stereoscopic image may be viewed on a portable computer which is configured to be wearable. Addition improvements in the mode of use of such wearable support are also addressed.

### BACKGROUND TO THE INVENTION

Cameras have been disclosed which are adapted to be connected to a portable computer, particularly to a tablet computer which is handheld, in order that camera operation may be controlled using the touch screen of the computer to accept user commands. For example: the popular GoPro™ style of “action camera” includes Wi-Fi wireless connectivity which enables connectivity with a nearby handheld tablet computer such as an iPad™

Data connectivity between camera and tablet computer has the advantage of providing the photographer with a much larger digital viewfinder as well as a remote means of controlling the camera. The major disadvantage of this arrangement is that, since two separate handheld devices must be supported and manipulated while taking photos, the ergonomics and overall usability are cumbersome. Ideally, one or even both of the devices could be mounted on the user's body in a manner that frees their hands.

Numerous support devices have been proposed to allow a user to carry a computer in a ready-to-use position in front of the user's body. A variety of arrangements proposed by the same inventor as herein for carrying a portable computer, making it essentially “wearable”, are described in PCT applications CA/2012/000342 and CA/2015/000276, the contents of which are adopted herein by reference.

The present invention addresses the need for an arrangement which enables a camera to be mounted to a “wearable”, body supported computer, thereby enabling both devices to be used in a mobile hands free synergistic manner.

Technology has been developed to enable persons to experience a three-dimensional image on the viewing screen of a cell phone or portable computer, such as a tablet computer. According to one variant, two distinct images taken from different angles of a scene are presented side-by-side on the viewing screen. A stereoscopic viewer having two lenses is then placed between a user and the screen. This stereoscopic viewer presents the respective images on the screen to the left and right eyes of the user, providing a three-dimensional viewing experience.

A similar 3D simulation may be achieved through presentation of differing images on the screen and viewing the respective images through corresponding colored or polarized filter lenses. A further technology employs electronically controlled shuttering lenses synchronized with alternating screen images. All modes of 3D viewing compatible with the disclosure below are addressed by the present invention.

This invention addresses an invention that facilitates 3D viewing of a body-supported portable computer.

Related references are:

Curtin's U.S. Pat. No. 4,730,898

Leong et al U.S. Pat. No. 9,069,527

The present invention addresses a configuration and procedure by which a person carrying a body-supported computer can readily experience a three-dimensional “Virtual Reality” (VR) viewing effect presented by the viewing screen of such computer in a manner not addressed in the prior art.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

### Camera Support

According to one aspect of the invention a portable computer is provided with a mount for connecting to and supporting a camera. Preferably, the camera is digital in operation and has the capacity either to take single frame images or video. The computer is further preferably provided with a body support system, or computer support, which allows the weight of the computer and camera combination to be carried by the body of a user.

According to one variant, the support for carrying the weight of the computer and camera comprises an upper body support member in the form of a neck strap or cord (hereinafter a “cord”) by which the weight of the computer may be carried by the upper body of the user. Preferably the upper body support member comprises adjustment means to permit the user to raise or lower the vertical location of the computer when carried by said user. The upper body support member may be detached from the computer support when the computer is in table-top use and in other convenient circumstances.

Additionally, and advantageously, the camera support system also includes a body propping member for positioning the computer outwardly from the torso of the user. This may include two movable arms with computer connections for connecting with the computer when present and outer deployable arm ends that are joined by a bridge to form a U-shaped propping member or “swingarm”, as described in the above PCT applications. It may also include any other form of body propping structure that positions the computer at a spaced distance from the torso of a user. Even without an upper body support member attached, this swing arm provides a convenient handle for grasping and holding a computer that is coupled to a camera.

Portable computers are generally equipped with their own frame. The above referenced support members may be attached directly to the frame of a computer. Alternately, the computer may be fitted into a holder, which may include a receiving case having a supporting surface underlying the computer and curled edges which will engage with and hold the receiving case firmly in place in respect of the computer. The holder or receiving case will generally be coplanar to the computer. When such a holder is present, the camera support members may connect to the holder. Other forms of holder arrangements may also be employed. Engagement with the computer as hereinafter described is intended to cover all such cases.

A camera, according to the invention may be coupled through a camera support connector either to the frame of a computer or to a holder which is engaged with the computer. This coupling is preferably located along the outer edge of the computer remote from the body of a user. In the case of a direct connection to the frame of the computer, or an indirect connection through a holder, the camera support connector can be affixed to the computer the frame or holder by any form of traditional connecting means.

The camera support connector can be unitary or it can be of a multi-part, preferably two- or three-part, structure by which a receiving guide is permanently attached to the computer in an unobtrusive manner, and the other part of the camera support connector may be slid, snapped, interfitted or otherwise positioned into readily removable engagement with the receiving guide. Such receiving guide may be fastened to the underside or edge of a computer, or holder by an adhesive connection, by screws, by being integral with the holder or by any other form of traditional connection means. In all cases, the function of the camera support connector combination is to stabilize the camera in its relationship to the computer. This relationship may be fixed, adjustable, or dynamically controllable so as to allow or cause the camera to direct its pointing axis in a preferred direction.

Whether unitary or made of multiple parts, the camera support connector is preferably configured to cause a camera carried thereby to point at an angle that is below the plane of the computer touchscreen, corresponding to an approximate horizontal orientation for the camera pointing direction. When the computer is being worn by a user so as to present the computer screen to the user at approximately 20° above the horizontal plane, a convenient angle for this configuration of the camera support connector may similarly be 20°. More particularly, such fixed angle provided by the camera support connector for pointing the camera may be in the range of 20°±10°, more preferably 20°±5°.

The camera support connector may also be articulated. It may allow adjusting the pointing direction of the camera to range about a single axis. This will allow for the camera to have differing pointing directions within a single, e.g. vertical, plane; and it may allow the camera to change its pointing direction about two axes, e.g. about both a vertical and horizontal plane. The pointing direction of the camera in such cases may be manually adjustable, as where a clamping bolt joins two limbs wherein the inner limb is fixed with respect to the computer and the outer limb which carries the camera may be rotated with respect to the inner limb about the clamping bolt. The clamping bolt may be tightened to stabilize the orientation of the two respective limbs to provide the desired camera pointing direction.

In a preferred embodiment the upper body support member comprises one or more cords that carry at least a portion of the weight of the computer through engagement points located proximate to the respective sides of the computer or case supporting the computer. Such cords may terminate at fixed anchor points, or may be disengageably attached to such anchor points. The anchor points are preferably located along the sides of the computer or computer support so as to carry the weight of the computer in an at least partially balanced manner. When a body propping member is in place, the need to provide fully balanced support for the weight of a computer is reduced. In such case, at least one of such cords may be connected to the computer or computer holder approximately along the line of the outermost edge of the computer when present. Preferably, such connection is made at one of the two corners of the computer or its supporting case.

As a preferred arrangement, the outer corners of the computer or computer support may be provided with fairlead guides to receive the upper body support cords when the computer is deployed. When the cords are provided with disengageable anchor points along the sides of the computer the ends of the cords, then when the computer is deployed, the anchor points may be switched to these fairleads. Alternately, and preferably, the cords remained anchored along the sides of the computer and, when the computer body support is deployed, one or both of the cords are routed through the fairleads with a sliding engagement.

Such fairleads may be in the form of protruding hooks or slots that guide the cord(s). Conveniently, these hooks may be used as attachment points for a camera support member.

An advantage of routing the neck strap or cord through positions which are located proximate to the outer two corners of a computer when present is to clear the sides of the computer of the interfering presence of such cords descending from the neck or shoulders of a user when the computer support is in its deployed mode. This provides improved manual access to the keyboard.

Howsoever the neck cords are anchored, such cords carry at least a portion of the weight of said computer when deployed and stabilize the computer while providing maximum user access to a keyboard on the computer.

A preferred format for the body propping member is an arrangement wherein: side arms provided as part of the body propping member are deployable from storage positions along the sides of and coplanar with the computer when present, from the stored positions to operating positions whereat the respective deployable ends of the arms are positioned for being supported by the torso of the user; the distal end of the sidearms remote from the point where the sidearms are connected to the computer are joined by a bridge to thereby form a U-shaped propping member, and once deployed at least one of such arms is provided with a computer connection which allows such arms to be disengageably fixable at the deployed position to allow locking of the U-shaped propping member in place.

The arms may connect directly to the computer as through clamps that engage the edge of the computer or through openings into the side edges of the computer which receive fasteners. Or the arms may be connected to a backing plate or containment case that extends between the two arms into which the computer is mounted. Collectively such structures comprise the computer connections for connecting the arms to a computer when present.

With the cords positioned to connect with the computer support or computer when present proximate to the outer two corners there will be a greater tendency for the bridge of the U-shaped propping member to slide down on the torso of a user. While this bridge may have a frictional engaging surface to resist this tendency, the bridge can be solidly positioned in place by employing a waist strap, preferably elasticized, that passes around the back of the user or is equivalently anchored to a waist-encircling garment of a user. The waist strap may not need be a unitary element but may be subdivided into components that connect with a garment being worn by a user. One or both of the two ends of such waist strap are then removeably connected to the U-shaped propping member, optionally with sliding engagements along the respective sidearms. When the computer is deployed this engagement point can be at a junction where a sidearm meets with the connecting bridge.

A preferred form of camera support is suitable for use when the outer corners of the computer or computer support are provided with fairlead guides in the form of protruding hooks. In this variant parts of the camera support engage with such a hook, the fairlead hook serving as a receiving guide. The respective parts of the resulting assembly are preferably disengageably engageable from the hook as well as with a camera.

A camera support connector may have an upper camera connector portion serving as a seat and a lower clamping bolt screwed into the seat through a fairlead hook. In this variant the upper camera connector may be screwed directly into the camera or into a base, optionally hinged, carrying the camera. Specialty quick-clip connectors may also be used as the camera seat provided a suitable camera connector is present in the camera.

Another embodiment of the camera support connector may compensate for the tilt angle of a computer screen by providing the seat of the upper camera connector (which is affixed to the fairlead) with a forward tilt. The seat, in the form of a bevelled top-ledge on the upper portion of the upper camera connector, can carry a threaded stud that engages directly with a threaded hole on the camera. Alternately an intermediate crown boss which is threaded into a camera on one side can include a centering hole on its other, lower, surface. This centering hole then slideably engages onto a positioning post carried on the bevelled seat portion of the upper camera connector fastened to the fairlead hook. This positioning post can be reciprocally mounted on the crown boss with the centering hole formed in the hook-mounted upper camera connector portion.

The post and hole engagement can be a sliding or friction fit or may rely on a magnetic attraction between the interfitting parts to secure the engagement. Any tendency for the camera to inadvertently swing left or right during use can be resisted by providing the positioning post and reciprocal hole with non-circular cross-sections that will lock against rotation.

A laterally extending arm can slidingly fit over the positioning post to support a side-mounted camera outboard of the computer support.

### 3D Viewing

According to another aspect of the invention a body-support portable computer is provided with a stereoscopic viewer that is positionable between the eyes of a user and a stereo image provided by the computer. The body support for the computer carries the weight of the computer on the user's torso, thereby providing such support in a hands-free manner.

Preferably, the body support for the computer includes straps or cords (“straps”) by which the computer is supported by the upper torso of a user in combination with a body-propping member. The straps are adjustable in their length. In particular and preferably, the straps are adjustable in their length to permit the computer to be located at a deployed position in front of a user that permits manual access to the screen in such viewing position, and an alternate position wherein the computer screen and stereoscopic viewer are held in close proximity to the face of a user. The body-propping member may optionally in either case be positioned on the user's chest to fine adjust the attitude and distance of the computer screen.

In the close proximity position, the user is able to obtain a stereoscopic viewing experience of the screen image presented on the screen of the computer. This latter position allows ready viewing of a stereoscopic image presented on the computer screen with a mere downward orientation of the user's head, retaining the ability of the user to raise his/her head to view the actual surrounding scene.

The arrangement, which enables a stereoscopic viewer to be mounted to a “wearable”, body supported computer, enables the computer to be used in a mobile, hands free synergistic manner. “Hands-free” in this context means that the user's hands need not be occupied with providing support for the computer and any camera attached thereto. Meanwhile, manual access to the screen remains available to the user, optionally and preferably even in stereoscopic viewing mode. For example, touch sensitive actuatable “buttons” on the viewing screen for camera control can be accessed without interfering with the viewing of the stereoscopic image.

According to one variant of the invention, the computer can carry or be supplied with data that will allow the generation of the stereoscopic image, wherein the data has been pre-recorded. As another feature of the invention, the body support, which carries the weight of the computer can, in turn, support a three-dimensional camera mounted thereon. This 3D data input device allows use of the user's body motion to control the stereo image scene being presented on the viewing screen of the computer. The camera may be controllable through actuatable control buttons present on the screen. The ability to access such buttons under these conditions is a valuable, though not essential, aspect of the invention.

The convenience of this variant of the invention arises from a body-supported strap system with straps of adjustable length which extends upwardly from the computer support to embrace the torso of a user over at least one of the user's shoulders, the straps being adjustable in their length to provide an adjustable separation between the viewing screen of the computer and the face of the user.

According to one variant, the neck strap may be composed of two pieces of linear material, such as nylon parachute-quality cord or the like, (hereafter all referred to as “straps”), that pass each other when crossing behind the neck of the user to respectively terminate on the front side of the torso of a user. In this version one end of each strap portion is connected to support the computer at a coupling point. The respective lengths of the portions of this composite strap may then be dimensioned to pass around the back of a user with their other ends terminating at special end connectors located proximate to the chest of the user.

These connectors are preferably compression-actuated clamps which effect, through a compression-actuated button, a sliding/locking engagement between the respective ends of one of the composite straps and an adjacent mid-portion of the other strap. Adjusting the positioning of the end connectors will adjust the vertical locations of the two computer-supporting ends of the strap portions, provided the strap portions are allowed to slide as they pass around the back of a user.

For the convenience of the user, the multiple strap portions may be contained within a protective sleeve at least for the sections along their lengths where such respective portions pass around the back of the neck of the user or over the back of the user. The use of such a sleeve isolates any sliding action by the strap portions from rubbing against the clothing or body of a wearer.

The adjustability of the straps permits the computer to be located at a deployed position in front of a user and at a viewing position wherein the computer screen is held in close proximity to the face of a user. In this position the user is able to obtain a stereoscopic viewing experience of a stereoscopic image presented on the screen of a computer when present.

The straps may connect with the computer support or computer when present along respective locations proximate to the sides of the computer. Or they may connect at one or both of the outer two corners of the under-computer support, proximate to the outer corners of a computer screen, when present. “Outer” in this case means remote from the torso of a user. The strap connections may be shiftable between the sides of the computer and such outer two corners to provide improved access to the screen when the computer is in its deployed position.

To resist any tendency for the bridge of the U-shaped propping member to slide down on the torso of a user this bridge may have a frictional engaging surface to resist this tendency. The bridge can be solidly positioned in place by employing a body-anchored tether as previously described. In use when stereoscopic viewing is to be experienced, the straps are shortened in their lengths and the connecting bridge between the sidearms is positioned higher up on the chest of a user. In this configuration a waist-anchored tether strap is advantageous to ensure balanced stability during deployment while the user is in motion.

A preferred form of stereoscopic viewer has the following features:
1. respective left and right lenses for viewing the stereoscopic image close-up to a user's face
2. a frame for holding such lenses
3. a mount extending from the frame for connecting to the computer support, or a computer when present.

A camera support connector may be mounted on the under-computer support along the outer line of the computer. If present, the data captured by the camera or 3D sensor may be fed directly into the computer by a wired connection or by telemetry. In the reverse direction, the camera can be controlled by commands issued by touching portions of the viewing screen of the computer that provide touch-sensitive control buttons.

### Light Cloak/Hat

To aid viewing the tablet computer's display in bright lighting conditions a light cloaking accessory may be provided that the user can deploy during lengthy viewing sessions to minimize interference from ambient lighting conditions. A preferred embodiment of this light-cloaking device comprises a sheet of lightweight opaque light-cloaking fabric that is fitted or anchored at one end to a user's head. This anchoring is preferable, though not necessarily effected through a hat or headband fitted to the user's head with provision for the fabric to be rolled-up to the edge of the hat for storage. Alternately, such fabric can be formed with a “head-pocket” at one end that engages over the back of the user's head. The balance of fabric in either case is dimensioned to be draped forward to hang past the edges of the deployed computer, thereby forming an opaque, tent-like viewing structure. The length of cloaking fabric overhang the tablet computer may terminate in one or more weights, magnets, a clamp, Velcro™ or similar fixation patches to provide sufficient tension on the fabric to maintain a tent-like structure.

To accommodate a mobile user wishing to quickly see out into the world a viewing flap may be included in the tent-like structure that the user can open or shut as needed. This flap may be invertible to be stored over a user's head. One suitable usage scenario for this viewing port is piloting small drone aircraft with the tablet computer. The availability to alternately engage in 3D viewing transmitted from a drone will enhance the drone piloting experience.

### Decorative Cargo Panel

A computer whether or not in its carrier or support may be provided with a detachable decorative cargo panel having an outer perimeter and shape that conforms approximately to the outer contours of the closed swingarm, thereby concealing the computer and/or support assembly while it is being shoulder-carried by the user. Preferably this panel has an inner elastomeric foam-core to which is bonded two outer layers of “UBL™” or “Velcro™ Loop” fabric on both sides for engaging with Velcro™ hook fasteners carried on the computer support. The fabric surface is preferably made of white polyester that enables digital images to be printed on either or both sides of the panel using the dye-sublimation printing. This decorative cargo panel when affixed in place conceals the underlying computer and/or computer support, improving its appearance.

One or more cargo modules with Velcro™ hook fasteners can be affixed to the outer surface of the cargo panel, thereby enabling the user to carry sundry items

### Dashboard Mounted Computer

The computer support of the invention can, with the swingarm locked at right angles to the computer, be attached to the dashboard of an automobile by engaging the swingarm with mounting fixtures fastened to the upper surface of the dash. These fixtures may be in the form of disengageable hooks or posts. The fairleads may rest on a lower portion of the dash, preferably on cushion patches, more preferably on patches with fairlead-engaging hooks.

The computer support can also be hung onto the steering wheel by its swingarm.

The computer support can further, with the swingarm parked, be detachably fitted into a specially constructed dashboard recess equipped with resilient latches.

### Carrying and Wearing a Dual-Mode Computer

A laptop-style computer of the “Folding Book” dual-mode format with a screen that can be swung through 360 degrees for positioning beneath its keyboard can be mounted in the computer support of the invention if the computer, or casing for the screen and keyboard, is provided with an special hinge. To avoid having the touchscreen collide with the backplate of the computer support when swung round, the hinge is re-configured to accommodate the thickness of backplate. This can be effected by using a multi-axis hinge that provides a gap when the screen is swung-round to underlie the keyboard. With this type of hinge the touchscreen will seat flush against backplate when fully rotated.

The foregoing summarizes the principal features of the invention and some of its optional aspects. The invention may be further understood by the description of the preferred embodiments, in conjunction with the drawings, which now follow.

Wherever ranges of values are referenced within this specification, sub-ranges therein are intended to be included within the scope of the invention unless otherwise indicated or are incompatible with such other variants. Where characteristics are attributed to one or another variant of the invention, unless otherwise indicated, such characteristics are intended to apply to all other variants of the invention where such characteristics are appropriate or compatible with such other variants.

### SUMMARY OF THE FIGURES

FIG. 1 is a perspective view of the body-supported computer support when deployed for use and with a suitable redirectable camera operatively mounted to it.

FIG. 2 is a close-up view of the camera support connector shown in FIG. 1.

FIG. 3 is an exploded view of the camera support connector shown in FIG. 2

FIG. 4 illustrates a fixed direction bevelled embodiment of the camera support connector of FIG. 2 that compensates for computer tilt angle.

FIG. 5 is a close-up view of FIG. 4 with the camera unscrewed from the upper connector.

FIG. 6 is an embodiment with a magnetic release for quick mounting and dismounting of the camera.

FIG. 6A depicts a modified, square-top, positioning post from that of FIG. 6 to support a side-mounted camera outboard of the computer support.

FIG. 6B depicts a laterally extending arm that can slidingly fit over the square-top positioning post of FIG. 6A fitted to a side-mounted camera positioned for mounting.

FIG. 6C depicts the hand-held side-mounted camera of FIG. 6B in use

FIG. 7 is a view of the embodiment of FIG. 6 mounting a different style of camera.

FIG. 8 is a view of the embodiment of FIG. 6 mounting a camera configured for 3D sensing.

FIG. 9 is a view of the computer support and camera support of FIG. 1 when reconfigured by being folded flat for transport. This figure also shows a threaded hole in the center of the backplate for mounting the computer support on a tripod.

FIG. 10 shows the computer support of FIG. 9 mounted on a tripod and carrying a laptop-style computer.

FIG. 11 is a perspective view of the computer support of FIG. 1 fitted with a binocular viewing apparatus to provide 3-D stereo viewing.

FIG. 12 is a close-up view of the binocular viewing apparatus shown in FIG. 11.

FIG. 13 reproduces FIGS. 8 and 11 to show a “3D camera” combined with a 3-D viewer.

FIG. 14 is a pictorial view of a “cloaking-hat” similar to that of a “Legionnaire's Hat” with an affixed sheet of cloaking fabric with viewing flap that can hang forward, or from the user's head when the hat is reversed, to darken the viewing space around the computer.

FIG. 15 illustrates a decorative cargo panel that can be attached to the hinged screen cover of the computer support before positioning.

FIG. 16 illustrates the decorative cargo panel of FIG. 15 when affixed to the computer support.

FIG. 17 illustrates the decorative cargo panel of FIG. 15 having had one or both of its sides printed with a decorative graphic.

FIG. 18 illustrates the decorated cargo panel of FIG. 17 when affixed to the computer support

FIG. 19 illustrates cargo panel of FIG. 16 with a cargo module affixed to its outer surface.

FIG. 20 illustrates an existing car dashboard with the computer support detachably affixed to it such that the computer screen can serve as a driving aid.

FIG. 21 illustrates the computer support of FIG. 20 when detached from the dashboard and hung on the steering wheel for hands-free use of the computer while the car is parked.

FIG. 22 illustrates a large-scale view of FIG. 21 showing details of the attachment fixtures used to attach the computer support to the dashboard.

FIG. 23 is a large-scale view of how the computer support's neckstrap fairleads engage onto lower dash latching fixture to provide secure attachment.

FIG. 24 illustrates another embodiment in which the computer support is attached in its compact storage configuration to a purpose-built locking alcove formed in the car's dashboard.

FIG. 25 illustrates an embodiment adapted for use with dual-mode computers that by inverting the support can be worn and used as either a laptop style of computer and a tablet style of computer.

FIG. 26 illustrates the embodiment of FIG. 25 with the computer configured as a tablet and the computer support worn upside-down with respect to FIG. 25.

FIG. 27 illustrates the embodiment of FIG. 25 with the computer configured for transport.

FIG. 28 illustrates the embodiment of FIG. 25 with both the computer and the wearable computer support configured for transport.

### DESCRIPTION OF THE PREFERRED EMBODIMENTS

### Camera Support

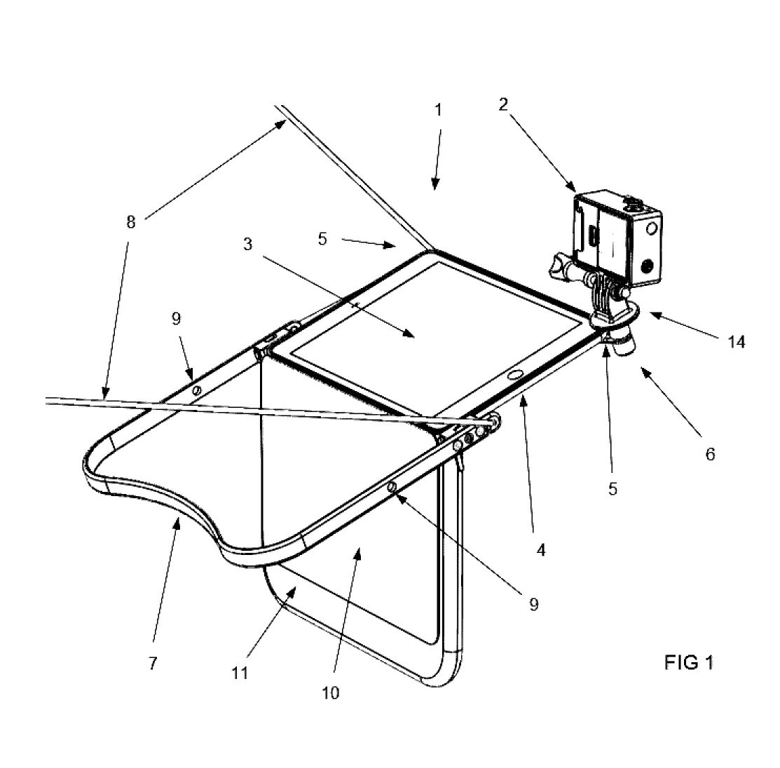

FIG. 1 illustrates a body-supported computer carrier or support 1 mounting camera 2 by means of camera connector 6. Computer support 1 includes receiving case 4, which receives and mounts tablet computer 3. U-shaped body-propping member or “swingarm” 7 has been rotated and locked into its operative position as described in PCT application CA/2015/000276. Threaded ¼-20 holes 9 in swingarm 7 can be used as attachment points as described further below.

Neckstrap 8 is configured for asymmetric wearing by the user such that its right portion passes under their right arm, crosses diagonally across their back, whereupon the left portion reaches over their left shoulder for support of the computer support 1 at its (hidden) left, hook-shaped neckstrap cord fairlead 5.

In FIG. 1 detachable fabric cargo pouch or storage bag 11 may be used to transport camera 2 and its connector 6 when not in use as well as other compact accessories. Bag 11 is affixed to receiving case screen cover 10 so that, when the swingarm 7 is rotated 180 degrees and the screen cover 10 is closed, the assembly can be carried by the neckstrap cords 8 and used as a shoulderbag.

The camera 2 shown is a “GoPro™ style of “digital action camera” that includes a wireless data connection with tablet computer 3 such that images it senses are displayed in real-time on the touchscreen and the touchscreen can control the camera. The illustrated style of camera 2 also includes a base with a hinge 14 that enables it to be fixed at a desired vertical angle.

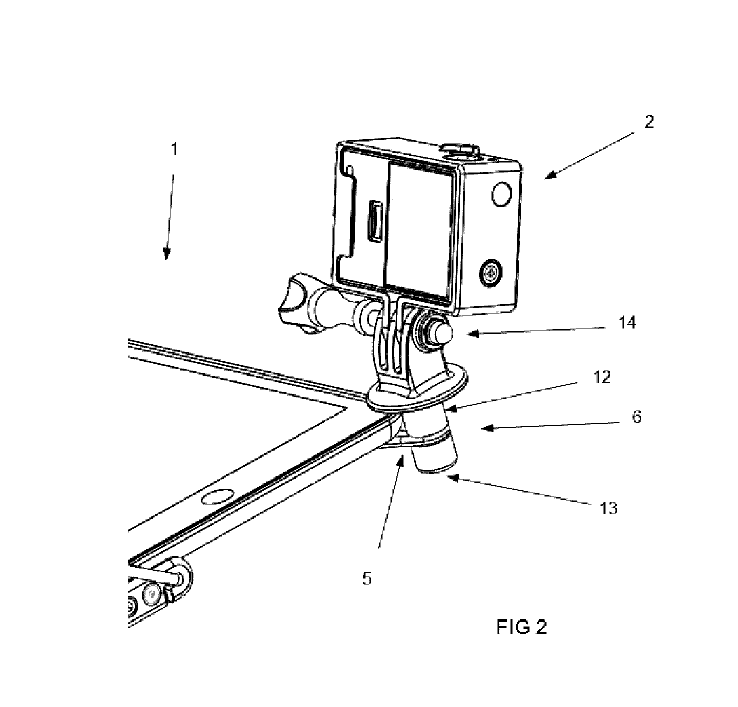

FIG. 2 is a close-up view of the camera support connector 6 shown in FIG. 1. Camera 2 is rigidly affixed to computer support 1 by means of camera support connector 6. Connector 6 comprises upper camera connector 12 serving as a seat and lower clamping bolt 13 screwed together through right cord fairlead 5. The camera 2 is screwed directly to the base with hinge 14.

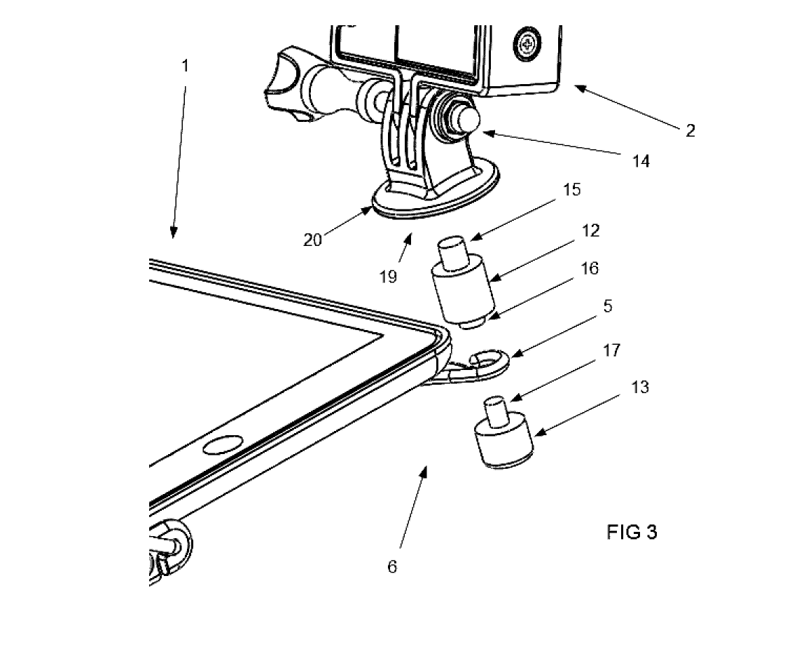

FIG. 3 is an exploded view of FIG. 2. Upper camera connector 12 includes an upper camera stud 15 and a lower fairlead centering boss 16. Camera stud 15 can have a ¼-20 thread (not illustrated) that enables connector 12 to screw into the standard threaded mounting hole found on most cameras as well as the base with hinge 14 as depicted. Threads other than ¼-20 or known specialty quick-clip connectors may also be used in place of camera stud 15 provided a suitable female connector is present in camera 2.

The GoPro™ style of camera 2 shown in FIG. 3 includes mounting boss 20 and fixable hinge 14 which together provide a suitably configured camera mounting hole 19 (not directly visible) on the underside of the base with hinge 14 for mating boss 20 to upper camera stud 15 on upper connector 12. In a preferred embodiment of connector 12, a lower centering boss 16 is provided and dimensioned for snug fit into through fairlead 5 to at least half of its thickness and includes a central threaded hole in its lower surface. Lower clamping bolt 13 includes an upper threaded stud 17 that screws into the threaded hole of connector 12, thereby enabling the user to clamp the upper and lower parts of camera support connector 6 together, affixed to fairlead 5. This configuration affixes camera stud 15 coaxial to fairlead 5 and thereby mounts camera 2 as shown in FIG. 1.

FIG. 1 and PCT CA/2015/000276 both illustrate that, while the user is wearing computer support 1 in its opened mobile mode, tablet computer 3, containment case 4 and cord fairleads 5 need to be tilted upwards at approximately 20 degree in order to face towards the user more nearly orthogonally and thereby facilitate optimal touchscreen ergonomics. Affixing the camera's viewing axis such that it's parallel to the upwardly tilted tablet would diminish this ergonomic synergy because it would force the user to awkwardly bend forward in order to view what is directly in front of them on the camera. The base component with mounting boss 20 and its fixable hinge 14 in FIGS. 1-3 eliminate that problem by enabling the user to adjust the camera's pointing angle to restore comfortable touchscreen ergonomics. The disadvantage of this configuration is that only a small proportion of available cameras accessories include the necessary hinge 14.

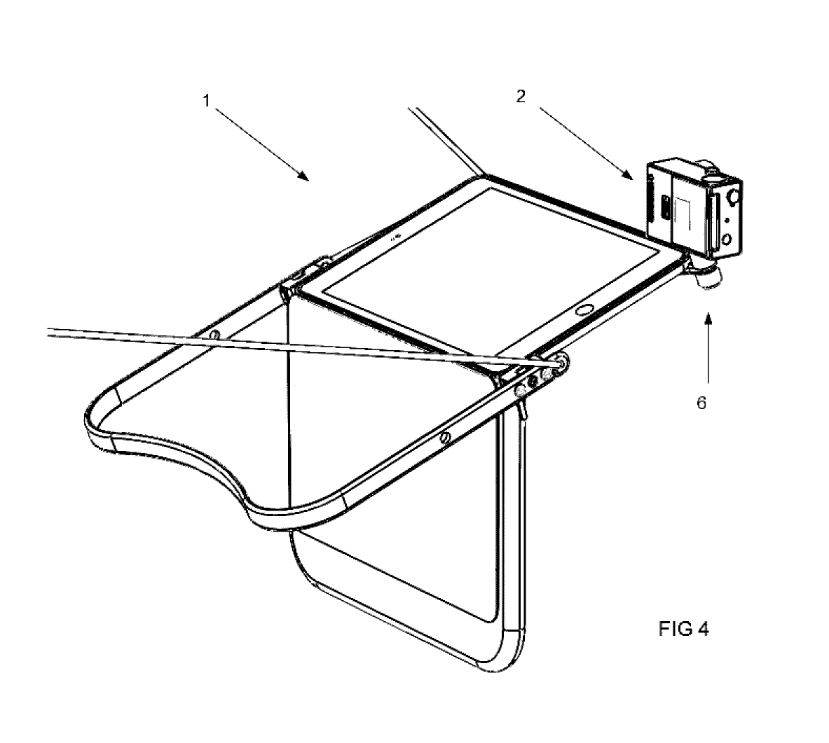

FIG. 4 illustrates another embodiment of the camera support connector 6 that compensates for tilt angle without the need for hinge 14. Since virtually all cameras are equipped with a ¼-20 threaded mounting hole corresponding to hole 19 on their lower surface, this embodiment of connector 6 enables a wide variety of “point and shoot” or “DSLR” style of cameras to be mounted horizontally onto a tilted computer support 1.

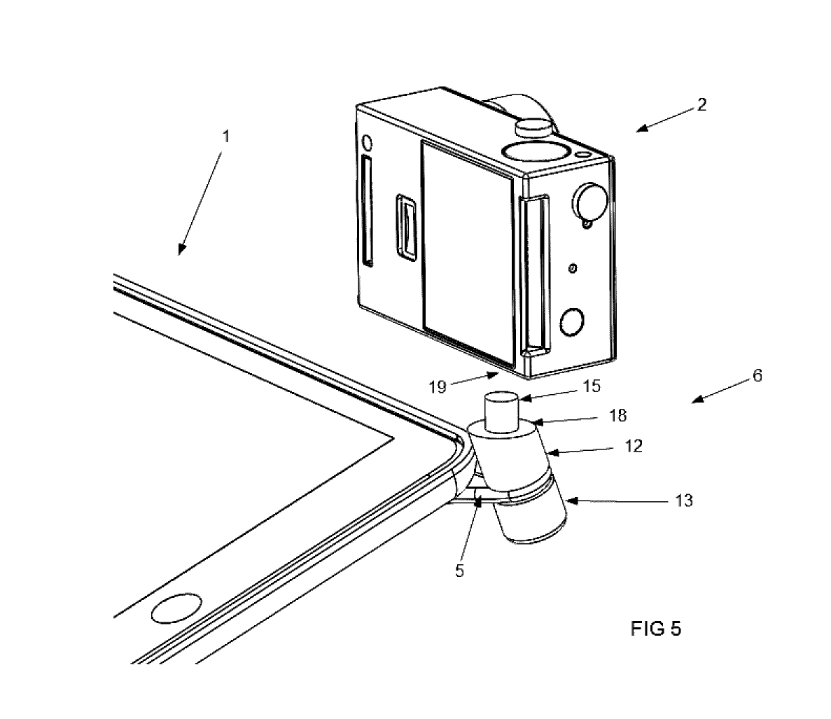

FIG. 5 is a close-up view of the camera support connector 6 of FIG. 4 but with camera 2 detached from upper camera connector 12 for clarity. To achieve the approximately 20 degree forward camera-tilt provided by hinge 14 in FIG. 3, bevelled top-ledge 18 is used to incline camera stud 15 forward and provide a matching support surface for the bottom of camera 2. To mount camera 2 onto fairlead 5, the now threaded camera stud 15 is first tightened into the threaded camera mounting hole 19. To insure that the camera 2 is correctly oriented forward, the thread starts on stud 15 are machined such that, when fully seated into the camera, its view axis points through the lowest point on bevelled top-ledge 18. Washers serving as shims can also be employed to achieve this result. The camera 2 and its attached connector 12 are then affixed through fairlead 5 by tightening clamping bolt 13 into camera connector 12 as shown. The disadvantage of this embodiment is that the camera 2 cannot be quickly mounted or dismounted to enable the computer support 1 to be folded into its compact carrying mode.

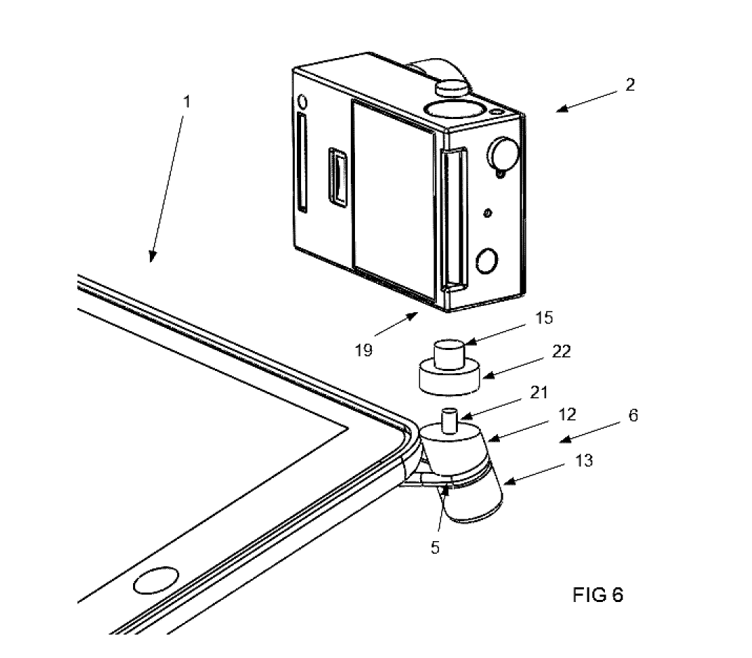

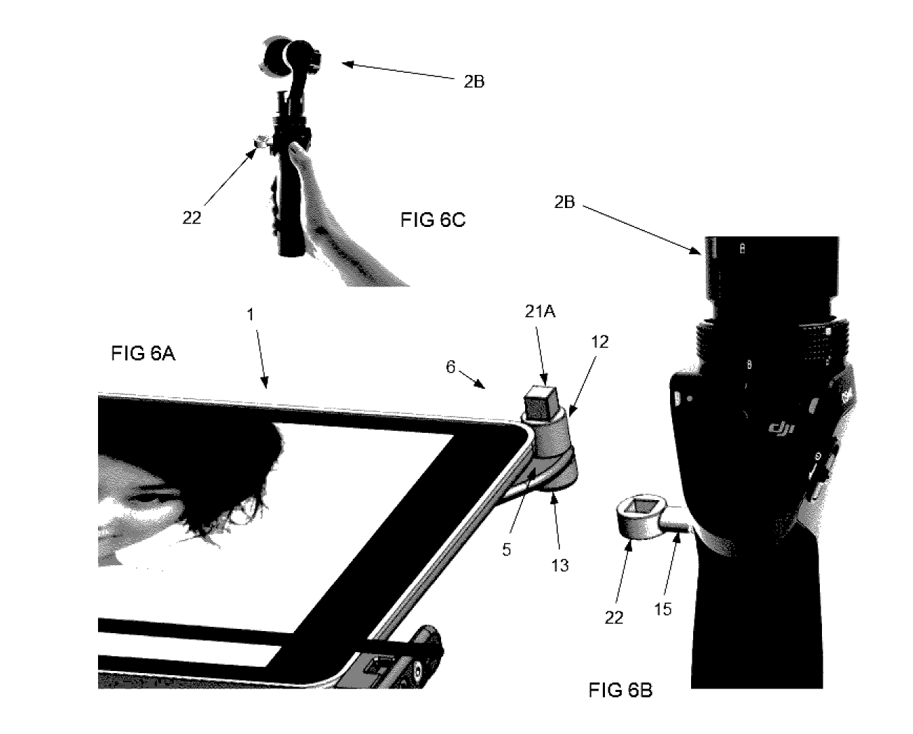

FIG. 6 is an embodiment of the invention that includes a magnetic release for quick mounting and dismounting of the camera 2. Threaded camera stud 15 is carried on removable crown boss 22 which includes a centering hole on it lower surface (not visible) that slideably engages onto positioning post 21 on camera connector 12. Once crown boss 22 has been screwed securely into the threaded hole 19 of camera 2, properly oriented, the user can quickly mount or dismount their camera 2 by mating positioning post 21 into its corresponding hole.

A friction fit may be used to secure the camera 2 from inadvertently swinging left or right during use; however in a preferred embodiment crown 22 and connector 12 carry opposite magnetic polarities that cause them to snap firmly together as needed. Positioning post 21 is shown with a round cross-section however other cross-sections may be used to enable positive rotational locking of the magnetically mated parts: for example a square post 21A would enable the user to more easily snap their camera onto or off of body-supported computer support 1 while maintaining a forward-looking view on their computer's touchscreen.

In FIG. 6A a modified, square-top, positioning post 21A analogous to that (21) of FIG. 6 is able to receive a side-mounting camera 2B. The depicted model is the DJI Osmo hand-held camera having automatic motion compensation. An outwardly extending arm 22A is fitted to the side-mounting camera 2B and shaped for mounting on the square post 21A. FIG. 6C depicts the hand-held side-mounted camera of FIG. 6B in use.

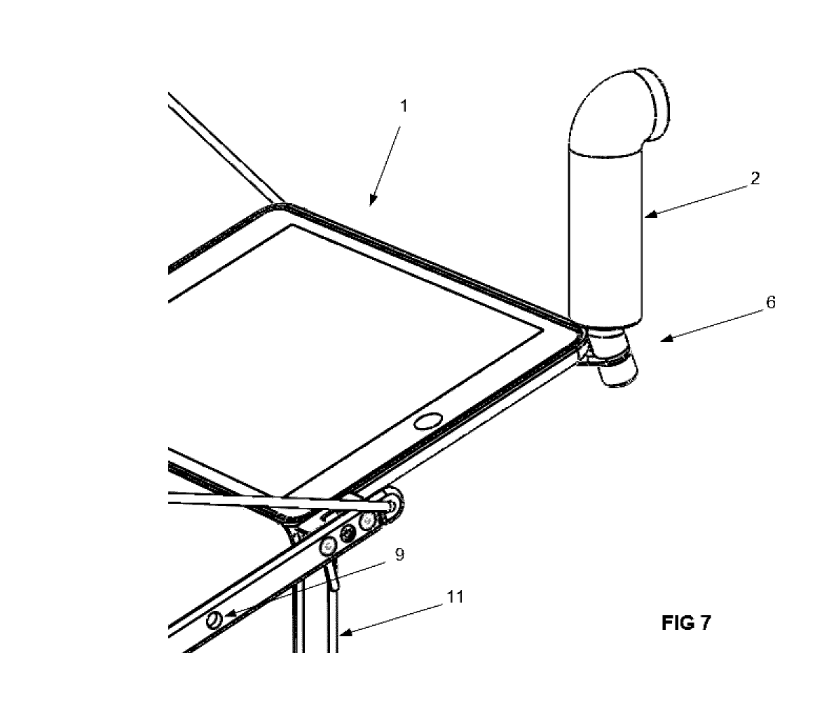

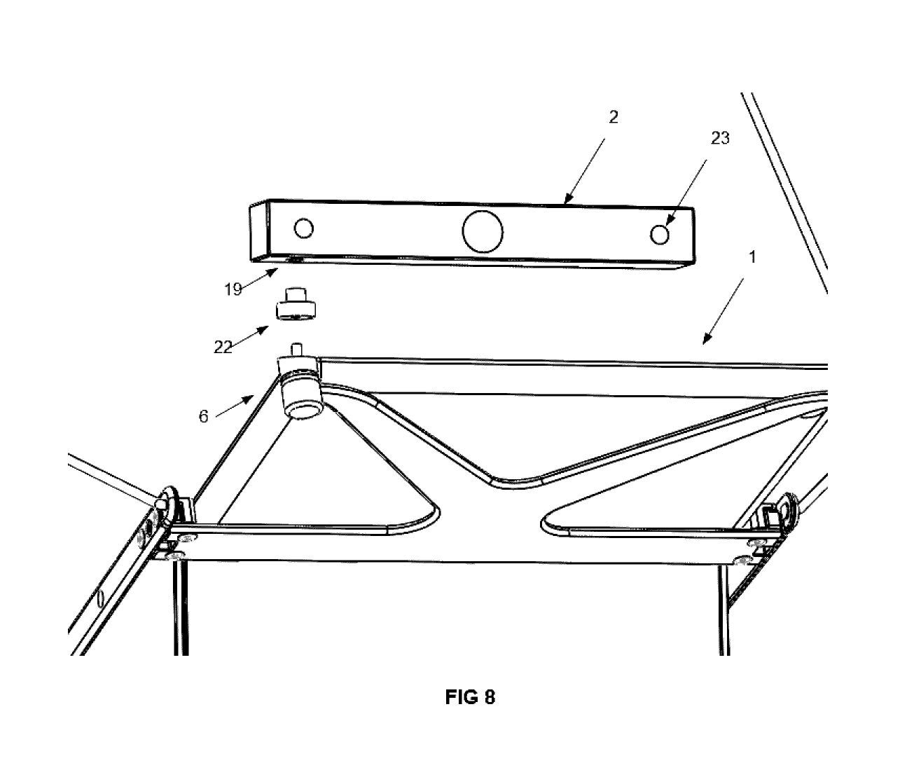

FIG. 7 is a view of the embodiment of FIG. 6 mounting a different style of camera 2, in this case a periscope-shaped HTC re™. Camera connector 6 may also be used to adapt sundry items for convenient temporary storage on computer support 1. For example: a touchscreen stylus might be configured with a suitable hole and magnet for storing it conveniently while computer support 1 is configured for wearing it while mobile.

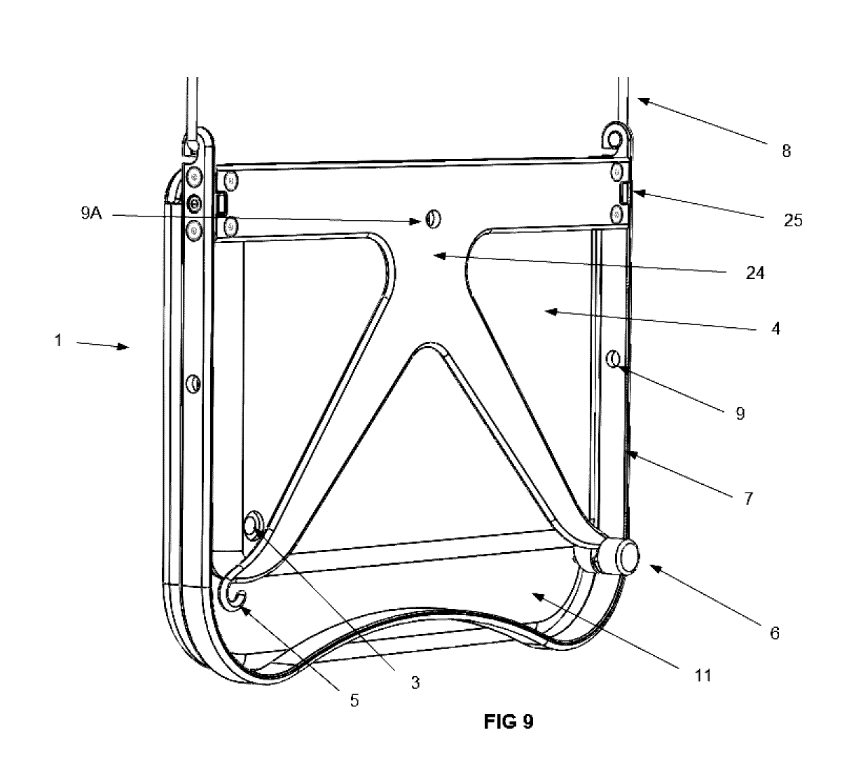

FIG. 8 is a view of the embodiment of FIG. 6 mounting a specialized camera configured for 3D sensing. Camera 2 includes a plurality of forward-facing 3D sensors 23 that communicate spatial information for display on the touchscreen of wearable computer. Sensors 23 will typically be spaced-apart image sensors that produce stereoscopic data that is processed for display and robotic navigation purposes. An ultrasonic ranging sensor may also be used to augment the accuracy and completeness of the 3D spatial model being sensed in front to the user.

This general configuration is well-adapted to the needs of Google's “Project Tango™” device. That device is essentially a specialized handheld tablet with 3D sensors built into its forward edge. The embodiment of FIG. 8 improves the ergonomic efficiency of “Tango Tablets”; for example: it adapts the tablet for hands free wearability by a blind person. Furthermore, since the specialized 3D sensors are localised in a separate camera 2, the cost-effectiveness of providing Tango Tablets is improved because all conventional tablets can be easily upgraded by carrying them in a suitably configured support 1 mated with a suitably configured 3D camera 2.

FIG. 9 is a view of the computer support 1 and camera support 6 of FIG. 6 when reconfigured for transport as described in the above-reference PCT applications. U-shaped body-propping member 7 (the “swingarm”) has been unlocked and rotated through 180 degrees to its parked location. Tablet computer 3 held within containment case 4 is rotatably connected to swingarm 7 through backplate 24 and rotational locks 25. The backplate 24 is genially parallel to the body and screen of the computer 3. Neckstrap cord 8 has been disengaged in FIG. 9 from fairlead 5 so that computer support 1 can be worn and carried by the user with its optional cargo bag 11 serving as a shoulder bag for transporting sundry items. Camera 2 and crown boss 22 have been disengaged from their magnetic mate 12 within camera connector 6 and removed so that the remaining components of camera connector 6 affixed to a cord fairlead 5 can swing through U-shaped propping member 7 and be parked during transport.

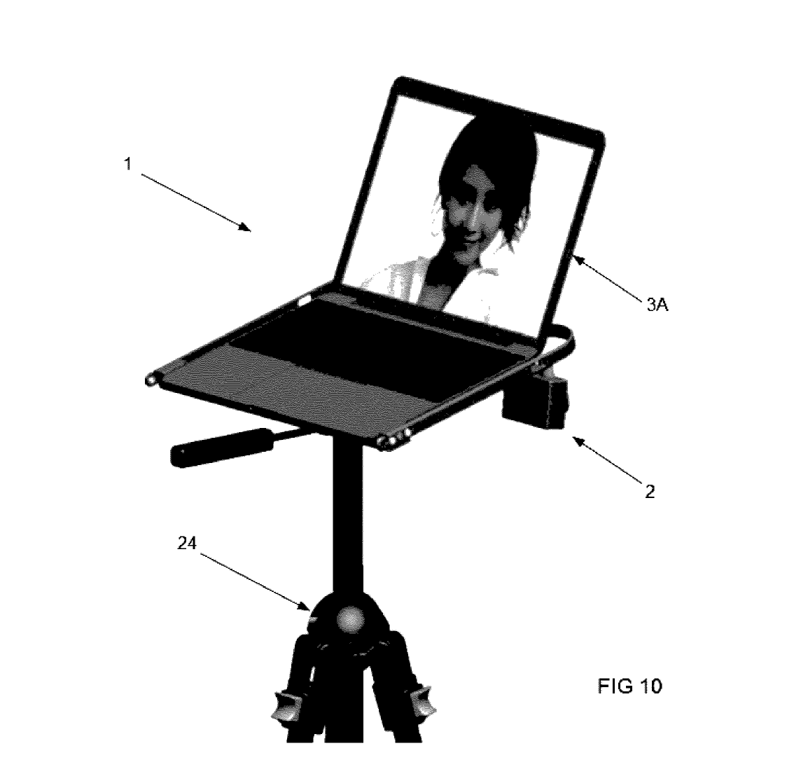

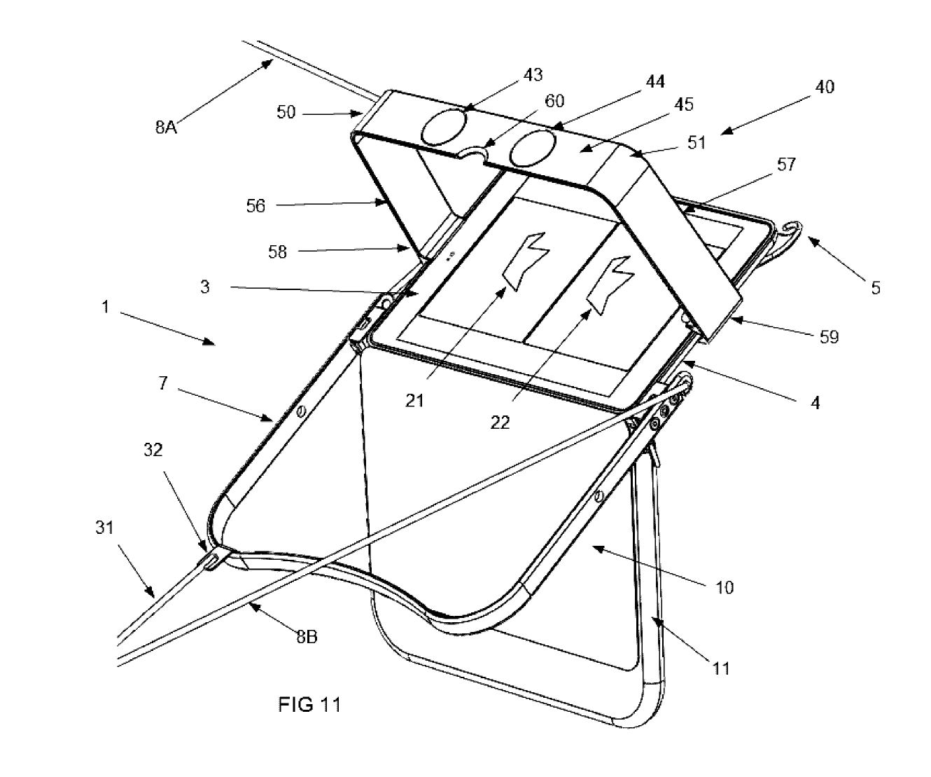

The lens for the tablet camera of tablet computer 3 is visible through containment case 4. Note that ¼-20 threaded holes 9 in swingarm 7 enable the computer support 1 to be mounted onto a floor-standing camera tripod (not illustrated but see FIG. 10). This feature of computer support 1 enables mobile users to stop and enjoy the photographic benefits of hands free stability, either using the tablet computer's built-in camera or an external camera that is wirelessly connected as described above. In the latter case, instead of mounting the external camera onto connector 6 for mobile use, it can be mounted onto swingarm 7. Since two threaded holes 9 may be provided on the respective arms, one may serve to affix the tablet 3 to a tripod and the second hole 9 may be used to mount an external camera or other photographic accessory such as a flash unit. Alternatively, the camera 2 of FIG. 1 can be mounted on a separate tripod and remotely controlled from a second tripod mounting the computer support 1.

In FIG. 9 further camera support threaded hole 9A is formed generally centrally in backplate 24. This hole 9A enables the computer support 1 carrying a portable computer 3 to be mounted horizontally onto a floor-standing camera tripod 26 (FIG. 10). This mounting arrangement provides improved stability and is also suited for when a separate camera 2 is mounted on a fairlead 5 beneath the plane of the computer support 1.

### 3D Viewing

In FIG. 11 the neck strap 8 has left and right neckstrap cord portions 8A and 8B which form an adjustable-length neckstrap loop around the user's torso (not visible). The illustrated wearing mode, is configured for asymmetric wearing by a right-handed user such that the neckstrap's right portion 8B passes under their right arm, crosses diagonally across their back, whereupon the left portion 8A reaches over their left shoulder for support of the computer support 1 at its (hidden) left, hook-shaped neckstrap cord fairlead 5. This asymmetric wearing configuration eliminates irritating pressure on the back of the user's neck.

Waist anchor strap 31 may be deployed to stabilize the asymmetric structure as the user moves about. Anchor strap 11 includes swingarm fixation means or engagement end 32 that secures swingarm 7 against the user's torso. Engagement end 32 is typically a Velcro hook tab that engages onto Velcro loop material affixed onto the inside of swingarm 7 (not illustrated). Optionally an engagement end 32 may be formed at both ends of an encircling waist strap (not shown) to attach to both corners of the swingarm 7. When not in use, each end of waist strap can be secured to the user for storage.

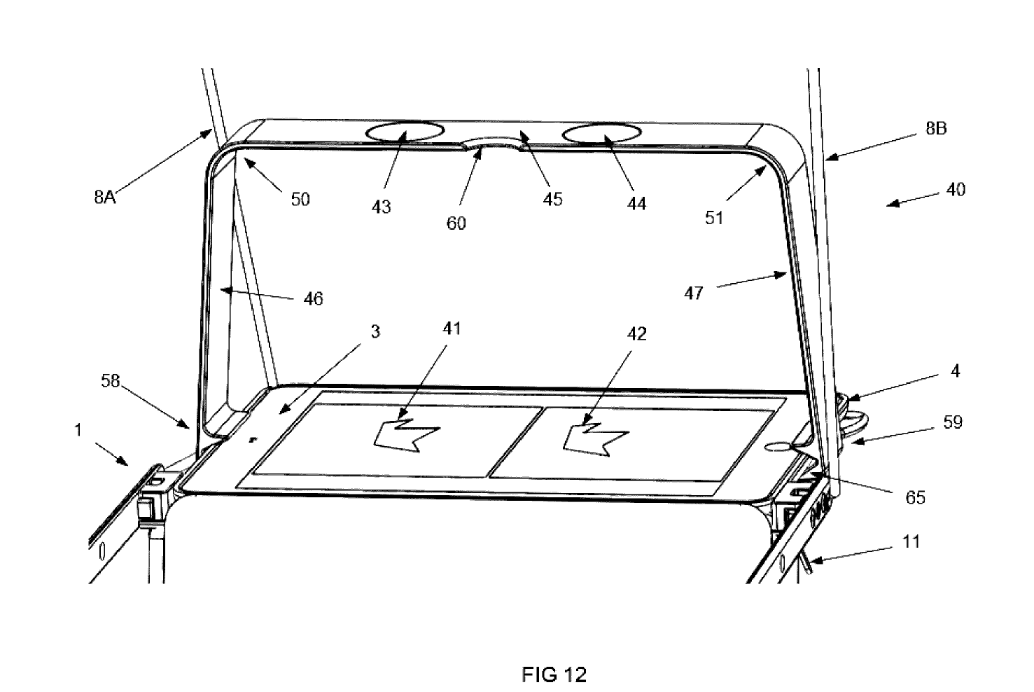

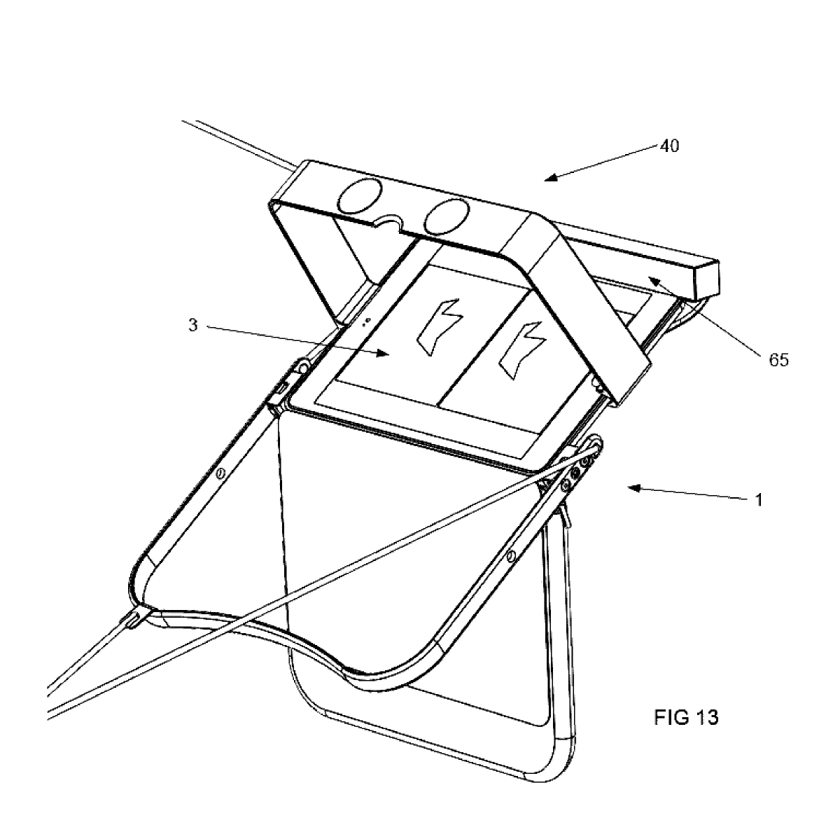

FIG. 11, and in close-up detail FIG. 12, depict binocular viewing apparatus or stereo viewer 40. Neckstrap portions 8A and 8B have been shortened such that tablet computer 3 is raised closer to the user's face. Swingarm 7 has been re-positioned onto the user's upper chest to adjust the angle of the tablet 3 for correct viewing and the elastic anchor strap 31 has been adjusted upwards along the user's torso to secure the apparatus close to the user's face. The reconfiguration is such that; when the user tilts their head forward, their eyes rotate downward to comfortably and effectively engage with stereo viewer 40.

Known software algorithms running on computer 3 generate and display left and right stereo images 41 and 42, each image portraying a different perspective view of a static or animated scene. Left and right viewing lenses 43 and 44 are configured and positioned within stereo viewer 40 such that when the user looks down and through them, images 41 and 42 fuse and are perceived as a realistic 3D model of the scene. Other types of stereoscopic images with corresponding viewers can similarly be presented to the user.

Note that this ability to simply tilt one's head forward to quickly consult a 3D model, while moving about with both hands free is a major advantage of the present invention with respect to handheld viewers such as the Google Cardboard™ or face-worn stereo viewers such as Samsung's Gear™.

Lenses 43 and 44 are affixed through horizontal viewer frame 45, which is supported and spaced above tablet computer 3 at their focal length by left and right viewer side frames 46 and 7. The lenses 43, 44 may be conventional convex magnification lenses as shown however other prior art optical configurations may to used. U.S. Pat. No. 4,730,898 by James Curtin discloses a useful prismatic lens configuration that is well-adapted for use in the present invention.

To improve optical performance, a useful configuration for lenses 43 and 44 (not illustrated) is to slideably mount them in frame 45 such that the distance between them can be adjusted to match the user's interpupillary distance. Nose cut-out 60 helps position a user's face on the stereo viewer 40. Side frames 46 and 47 are affixed to the horizontal portion of viewer frame 45 at left and right corners 50, 51 and angled such that their lower tablet-engagement fixtures 58 and 59 are positioned on or near the left and right edges of receiving case 4. In its preferred embodiment, the U-shaped structure of the viewer assembly is inwardly elastically biased to facilitate and enable the preferred means of engagement between viewer 40 and computer 3.

In FIG. 12 V-shaped notches 65 serve as form-fitted keyways that engage over the left and right sides of receiving case 4, thereby affixing stereo viewer 40 in place when stereoscopic screen-viewing is needed. The tablet engagement fixtures 58 and 59 may also be slideable for temporary displacement of the viewer 40 to an edge of the computer 3.

Corners 50 and 51 may be rigid monoliths formed at an approximate right-angle as shown. Alternatively, the corners 50, 51 may include a travel-stopped hinge (not illustrated) thereby enabling viewer side frames 46 and 47 to fold flat against the horizontal bridge portion of viewer frame 25. When thus folded (like conventional eyeglasses), viewer 40 can be conveniently stored and carried in a detachable storage pouch 14 that may be mounted on hinged screen cover 10.

The natural variability between different users' eyesight makes adjustable focus of lenses 43 and 44 desirable. One convenient way of providing that capability is to provide a plurality of viewer side frames 48 and 49 that enable the user to selectively affix viewer 40 to receiving case 4 at various heights (not illustrated).

Another feature that facilitates optimal viewing is the inclusion of a raised stand-off that protrudes from the stereo viewer immediately above lenses 23, 24 and spaces member 25 away from the user's face. This brow stand-off (not illustrated) is prior art from Curtin's “898” patent. When used in conjunction with nose cut-out 60 the brow stand-off forms a rudimentary “mask” onto which the user may tilt their face for faster registration and perception of the 3D stereo image. Another advantage of this rudimentary facemask is that when the user is lying prone in bed, gravity will cause the stereo viewer 40 to rest against their face. The brow stand-off and nose cut-out 60 will therefore make that face contact and pressure more ergonomic; cushioned edges may be provided along its contact edges to improve the user's facial comfort.

Note that by unhooking neckstrap cord 8B from the computer support's left fairlead hook 5 the computer 3 may be very quickly repositioned lower on the user's torso. Lengthening the neckstrap portion 8B can also be performed very quickly as per Kielland's PCT applications (above) to achieve the same lowering effect. Once lowered from upper-torso to lower-torso positions, if stereo viewer 40 is slid forward or removed and stored, the computer's 2D graphical user-interface can be used to perform a wide variety of conventional tablet computer tasks (including desktop applications when the swingarm is locked at 90 degrees). This ability to multitask between stereo viewing applications and 2D applications as well as making full use of the large-format tablet computer is a major advantage of the present invention with respect to small handheld viewers such as the Google Cardboard™ or face-worn stereo viewers such as the Oculus Rift™.

Note also that the space between the sides 46, 47 of the viewer 40 enable the user to access the computer's touchscreen to control the software and that this too is an advantage of the present invention with respect to closed-sided handheld viewers such as the Mattel's View-Master™ or closed-sided face-worn stereo viewers such as the Samsung Gear™.

FIG. 13 reproduces FIGS. 8 and 11 combined to showing a “3D camera” 66 (which may be of the type of Google's “Project Tango” environmental sensing technology), combined with 3-D viewer 40. Software running on the computer can integrate real-time motion-sensing data such that the 3D stereo model being projected through viewer 40 is driven by the user's real time activities.

### Light Cloak

A disadvantage of the present invention's open-access stereo viewing is that, in bright lighting conditions, the computer's display will have noticeably poorer contrast and be subject to unwanted reflections. To mitigate that image-quality problem, a light cloaking accessory may be provided that the user can deploy during lengthy viewing sessions in bright light conditions to create a local darkened viewing environment.

One embodiment of this light-cloaking device is a sheet of lightweight opaque light-cloaking fabric. To form a suitable light-cloak 61, one end of an approximately rectangular sheet of light-cloaking fabric is folded and fastened, e.g. sewn, together to form a “head-pocket” at one end that engages over the back of the user's head; the balance of fabric is dimensioned such that it can then be draped forward to hang past the edges of the deployed computer, thereby forming an opaque, tent-like viewing structure.

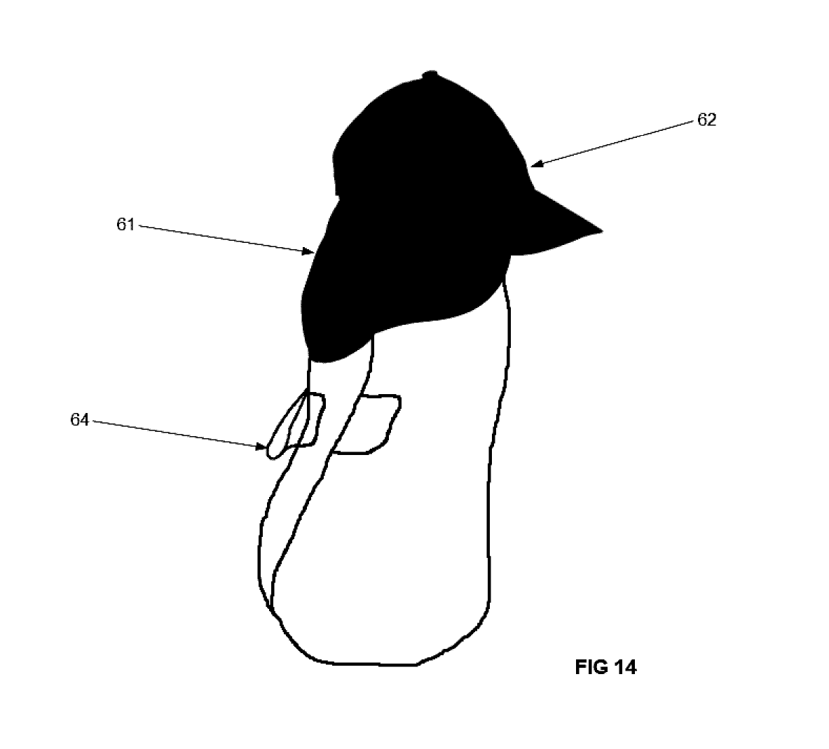

In FIG. 14 a sheet 61 of lightweight opaque light-cloaking fabric that is fitted or anchored at one end to a user's head through a hat 62 or headband fitted to the user's head with provision for the fabric 61 to be rolled-up to the edge of the hat 62 for storage. The hat 61 may be reversed on the user's head to deploy the light cloaking fabric 61. Or the fabric may be inverted over a user's head.

The general form of this “cloaking-hat” is similar to that of a “Legionnaire's Hat”; i.e. it includes an affixed sheet of cloaking fabric 61 that can hang down the back of the user's neck to prevent sunburn. In the case of the present invention, the hat's rear flap of cloaking fabric 61 is outlandishly large, thereby enabling to extend forward over the user's head and used as described above for improved viewing and operation of the body-worn computer 2. The length of cloaking fabric 61 overhanging the tablet computer 3 may terminate in one or more weights, magnets, a clamp, Velcro™ or similar fixation patches 63 to provide sufficient tension on the fabric 61 to maintain a tent-like structure.

To accommodate a mobile user wishing to quickly see out into the world a viewing flap 64 may be included in the tent-like structure that the user can open or shut as needed. This flap 64 may be invertible to be stored over a user's head.

When not formed as part of a hat 62 and not needed, the light-cloaking accessory 61 may be folded and carried in accessory bag 14.

To switch into its local viewing and navigation mode, the user grasps the front, overhanging edge of the viewing flap 64 and temporarily affixes it to the top of their cloaking-hat 62 using a Velcro or similar fixation so that it can quickly be redeployed over the computer 3. Alternatively, they can simply let the hat's entire light-cloaking portion hanging down their back for unobstructed viewing of the local environment.

### Decorative Cargo Panel

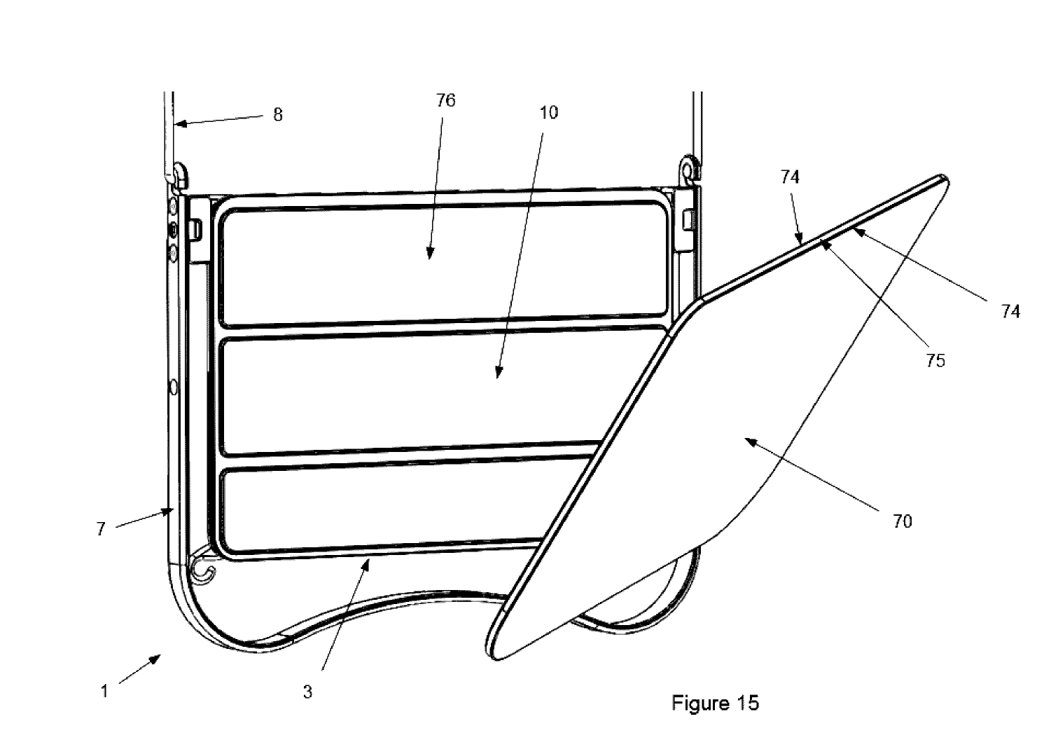

FIG. 15 illustrates a computer carrier or support 1, which receives and mounts tablet computer 3 and hinged screen-cover 10. Detachable decorative cargo panel 70 is positioned away from the computer support ready for attachment. Cargo panel 70 is formed from a sheet of fabric having an out perimeter and shape that conforms approximately to the outer contours of the closed swingarm (U-shaped propping member) 7, thereby concealing the computer support assembly while it is being shoulder-carried by the user with neckstrap 8.

The fabric used to form panel 70 is typically comprised of an inner foam-core 75 such as neoprene that gives it suitable flex characteristics. Inner fabric core 75 is bonded to outer layers of “UBL™” or “Velcro™ Loop” fabric 74 on both sides, thereby enabling Velcro™ hook fasteners to engage securely onto both sides of cargo panel 70. The UBL™ fabric surface 74 is preferably made of white polyester that enables digital images to be printed onto it using the dye-sublimation printing process commonly used to customize the fashion appearance of T-shirts.

Hinged screen-cover 10 is covered partially or wholly with a Velcro™ hook surface 76 that engages onto decorative cargo panel 70 to hold it in place. If computer 3 is a “laptop-style” or “Netbook” style of computer comprised of a hinged keyboard and display elements that form a clamshell computer rather than the “tablet-style” computer shown, the Velcro™ hook surface 76 used to attach panel 70 to the computer 3 is affixed to the back of the laptop's closed display panel (not illustrated) instead of the tablet computer's hinged cover 10.

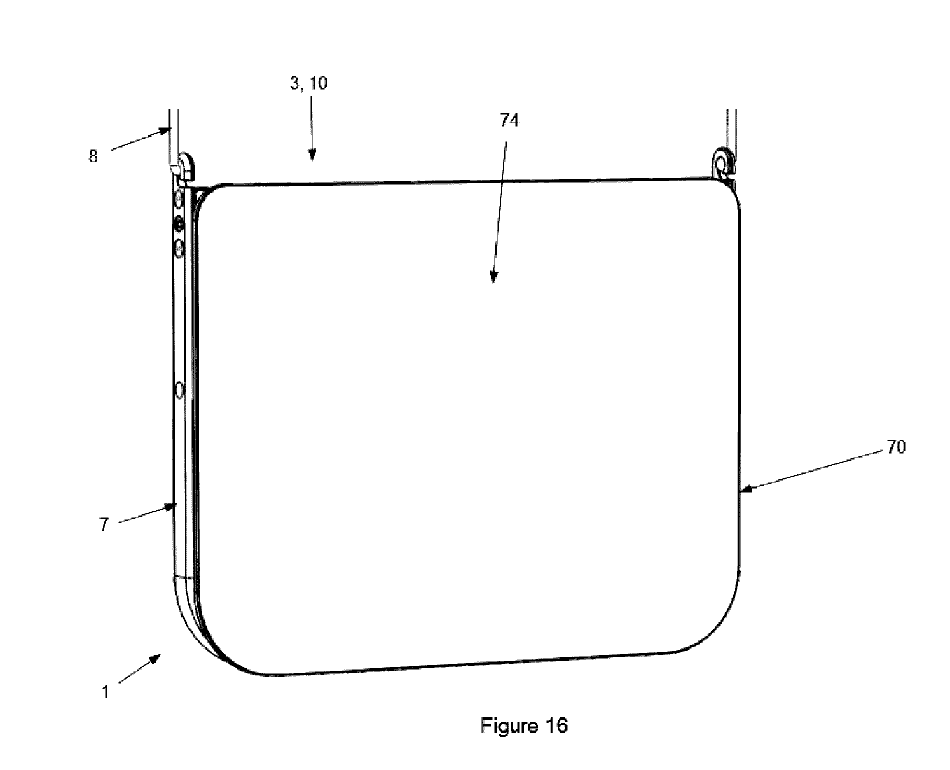

FIG. 16 shows the decorative cargo panel 70 of FIG. 15 when affixed in place to conceal the underlying computer 3 and computer support 1, thereby giving it an appearance somewhat similar to a shoulder bag when carried by the user. The opposite Velcro loop surface 74 of decorative cargo panel 70 is firmly mated to the Velcro™ hook surface 76 on the underlying hinged screen cover 10.

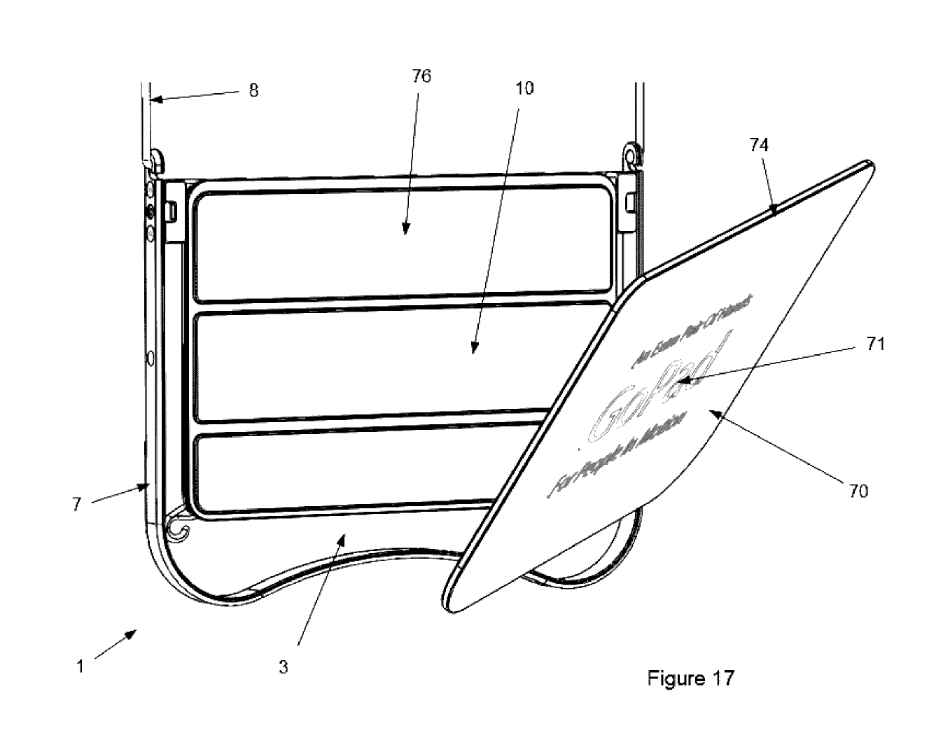

FIG. 17 shows the decorative cargo panel of FIG. 16 having a graphic 71 printed onto one side. If printed at a T-shirt customization shop using the dye-sublimation process, graphic 71 may be any full colour digital photograph provided by the user. Both sides of panel 70 may be printed with a different image to provide the user with a choice of which graphic is visible when the panel 70 is affixed over computer support 1.

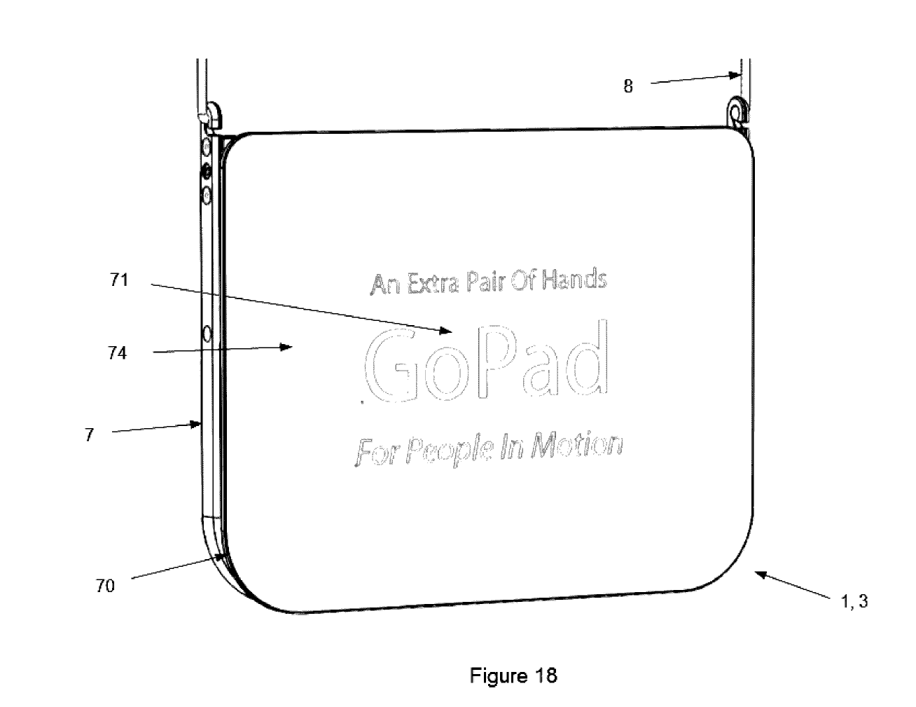

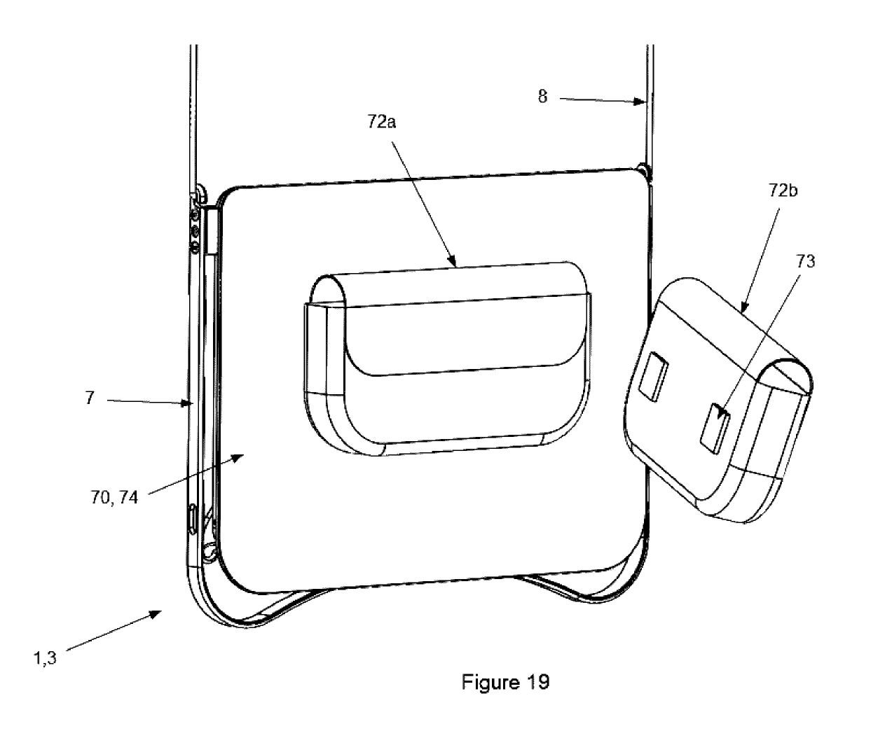

FIG. 18 shows the affixed printed decorative cargo panel 70 in place with the user's desired graphical image facing out while it is being worn as a shoulder bag by neckstrap 8. The ability to conceal the mechanism with any image enables the user to express a wide variety of fashion statements. They can maintain a “wardrobe” of various decorative cargo panels 70 that are printed to express their personal fashion preferences. Each cargo panel 70 may be reversed during the day to suite changing needs. For example: while at work they might show a company logo and reverse it after work to show a fabric design that fits a more casual setting. Users may also customize the appearance of cargo panel 70 using photographs of other apparel they own. For example printing a close-up photo the fabric of a new dress or shirt enables them to create a matching shoulderbag to complement their fashion appearance.

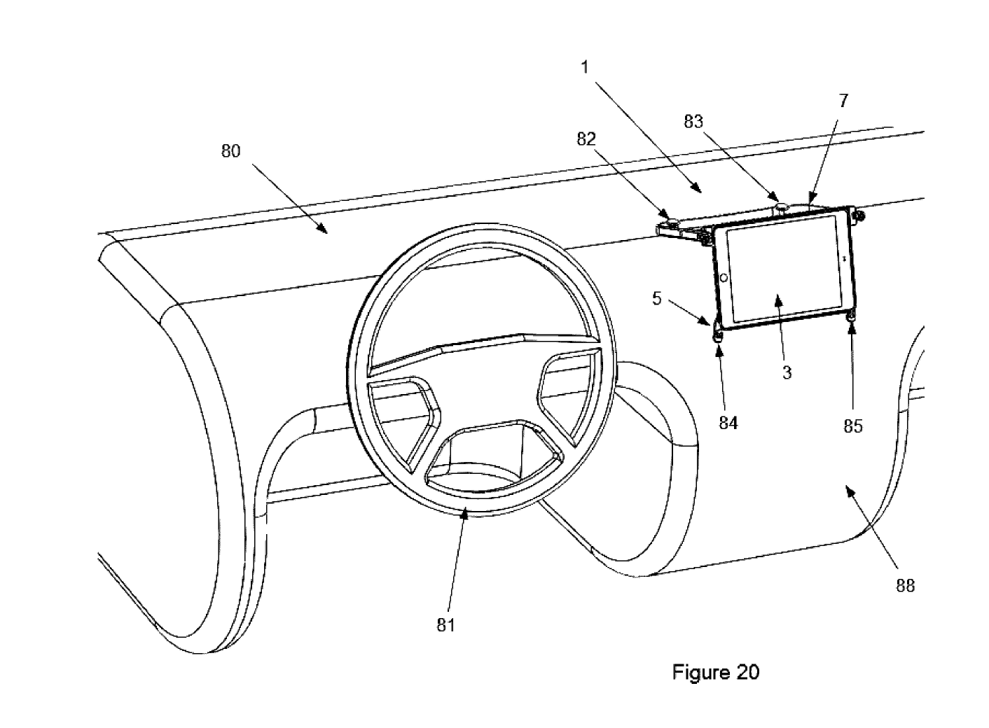

FIG. 19 shows the embodiment of FIG. 16 with cargo module 72a affixed to the outer surface of decorative cargo panel 70, thereby enabling the user to carry sundry items as they would in a conventional shoulderbag. A second cargo module 72b is shown to illustrate how Velcro™ hook patches 73 on the back of each cargo module 72a, 72b, engage onto the plush Velcro™ loop finish 74 of decorative cargo panel 70. Multiple sizes and styles of cargo model 72 may be used to complement the underlying graphics image when present. For example a trip to the beach might inspire a user to create a cargo panel printed with a beach scene and complement it by attaching a cargo module designed to hold sunglasses. Modules designed for efficient storage of computer accessories such as headphones or a battery charger might also be added to cargo panel 70 as needed. Since any object with Velcro™ hook patches on it can be attached to the printable loop finish 74 of cargo panel 70, various tools such as a smartphone or a screwdriver can be modified for direct transport on cargo panel 70 by affixing adhesive-backed hook patches 73 to them.

### Dashboard Mounted Computer

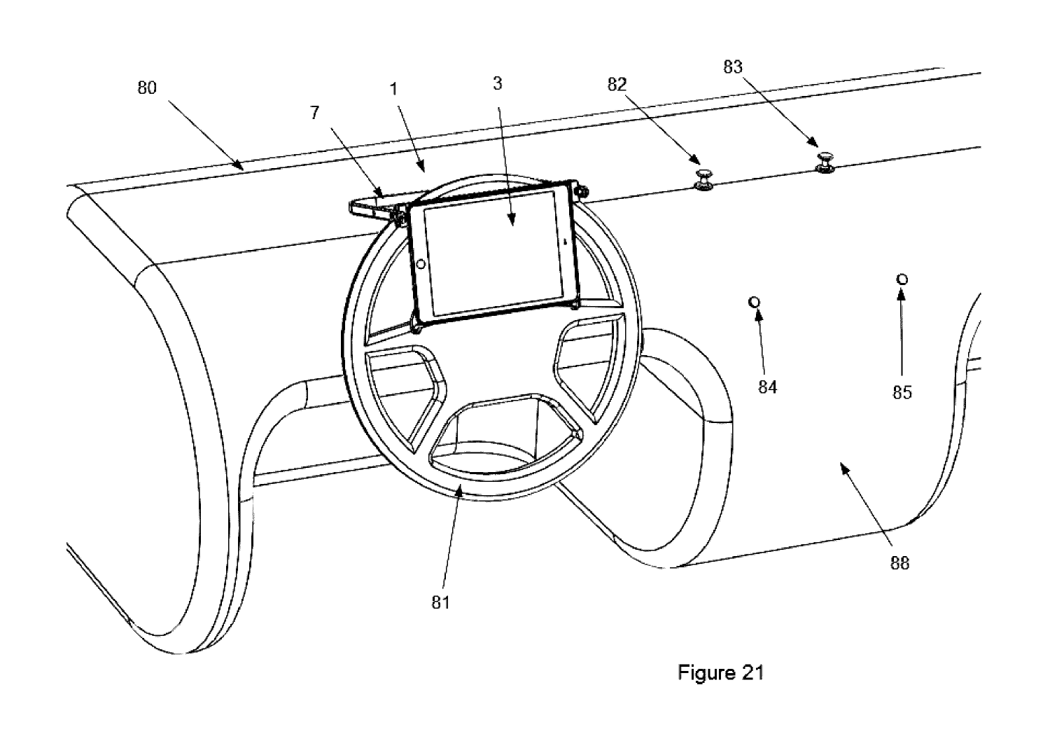

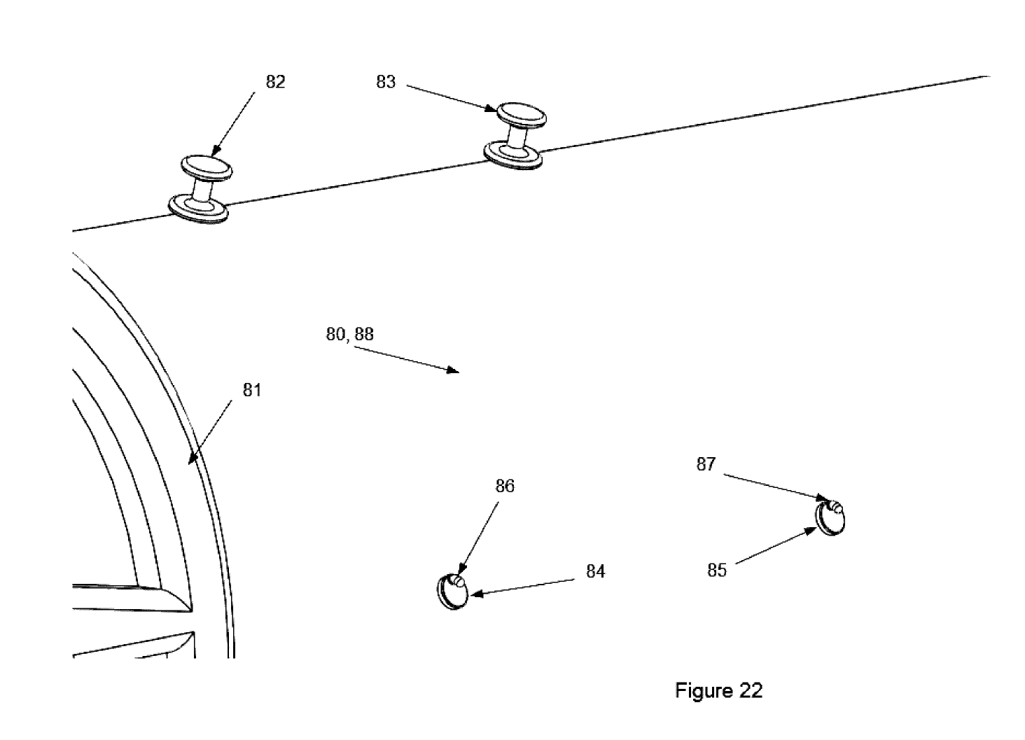

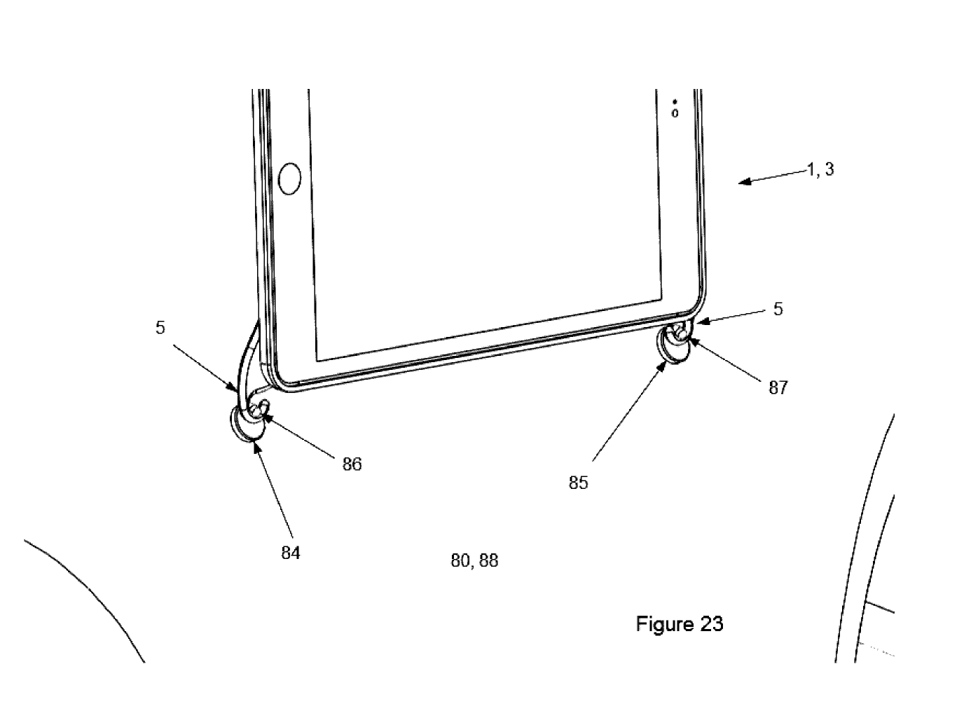

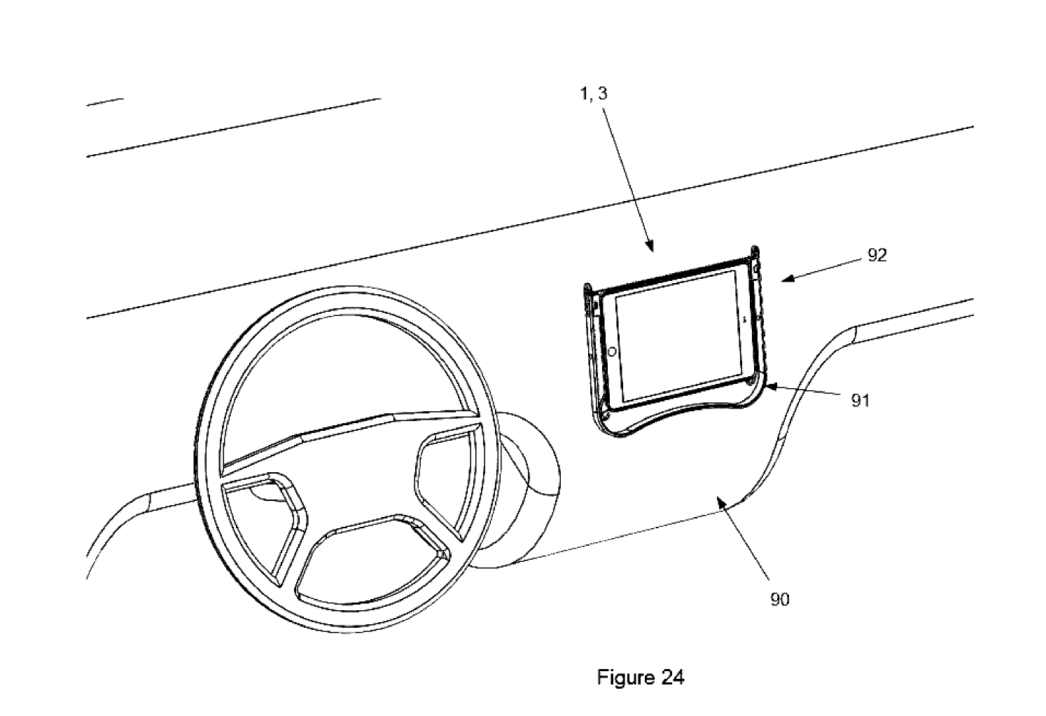

FIG. 20 illustrates another embodiment of the computer support 1 that can be attached to the dashboard of an existing automobile, thereby enabling the computer display to serve as a wearable “infotainment” center for use while the car is being driven. The interior of a typical car includes dashboard 80, steering wheel 81 and center console 88.

Computer support 1 is configured in its desktop stand usage mode wherein the swingarm 7 is locked at right angles to computer 3, and affixed to the central portion of dashboard 80 by engaging swingarm 7 onto upper mounting fixtures 82 and 83. Said upper mounting fixtures 82, 83 are hook-shaped or spool-shaped appliances dimensioned to engage around the upper and lower edges of swingarm 7; the user having positioned and securely affixed both mounting fixtures 82, 83 to their car's dashboard 80 as shown, thereby enables said fixtures 82, 83 to support the weight of computer support 1 while the car is being driven.

Note that the weight of the wearable computer support assembly 1 is carried in part by the neckstrap cord fairleads 5 bearing onto dashboard console 88. Lower fairlead engagement fixtures 84 and 85 may be optionally affixed to console 86 to prevent marring of its finish. Note also that the orthogonal structure of computer support 1 can be installed at a position on dashboard 80 and console 88 such that bridges over the complex shape which comprise typical car dashboards. Note also that to access obstructed dashboard controls that might be located behind computer 3, the user can simply lift the lower edge of computer 3 to rotate it and swingarm 7 about its engagement points on upper fixtures 82 and 83. Removal of the computer support from the dashboard is instantaneous if the swingarm is then unhooked from its upper engagement fixtures 82, 83. Note also that while hanging on the dashboard 80, the weight of the structure and force vectors bearing onto it tend to lock it in place during rapid acceleration and deceleration.

### Embodiment for Carrying and Wearing a Dual-Mode Computer

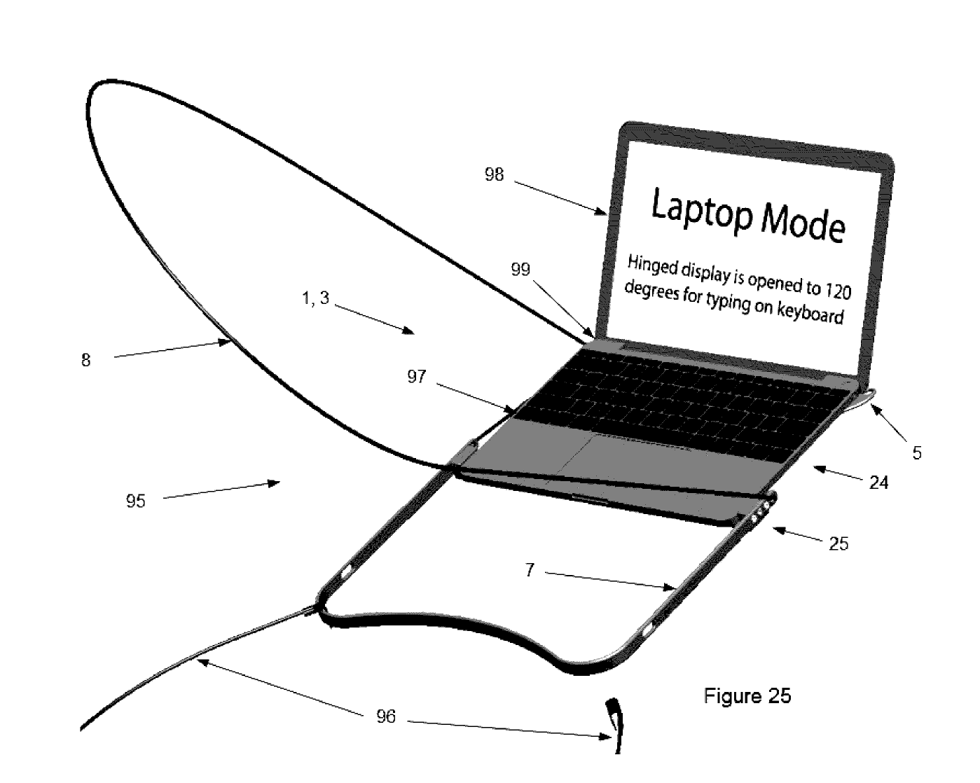

FIG. 25 illustrates computer support 1 configured for mobile wearing of laptop-style computer 3 by a user (not shown). Neckstrap 8 is deployed asymmetrically over the user's left shoulder and diagonally across their back; thereby preventing any pressure from the weight of the computer support 1 from bearing onto their neck. To further enhance wearing comfort, neckstrap 8 has also been (optionally) routed forward through the left hook-shaped fairlead 5 (hidden) thereby improving the user's ability to use the computer with their left hand while wearing their computer.

Note that the neckstrap cord fairleads 5 shown in FIG. 25 have a large-diameter hook shape that facilitates affixing the prior art camera-mount of FIG. 1. When practicing the present dual-mode wearable computer invention, which requires a hinged laptop-mode display portion 98, the computer's hinged display panel cannot rotate through 360 degrees without being arrested by the large diameter structure of fairlead 5. It is therefore advantageous to provide a more compact “tuning-fork” or “slot-style” shape of cord fairlead, outboard and parallel to the edge of computer 3 and that uses a narrower slot-style of neckstrap fairlead. Its narrower structure will be much easier to fabricate outboard of the computer and within the narrow confines of swingarm 7. Since prior art neckstrap 8 will typically be formed using ⅛″ parachute cord the use of a slot-style fairlead 5 slightly larger than ⅛″ is used in support 1 to enable 360-degree display panel rotation.

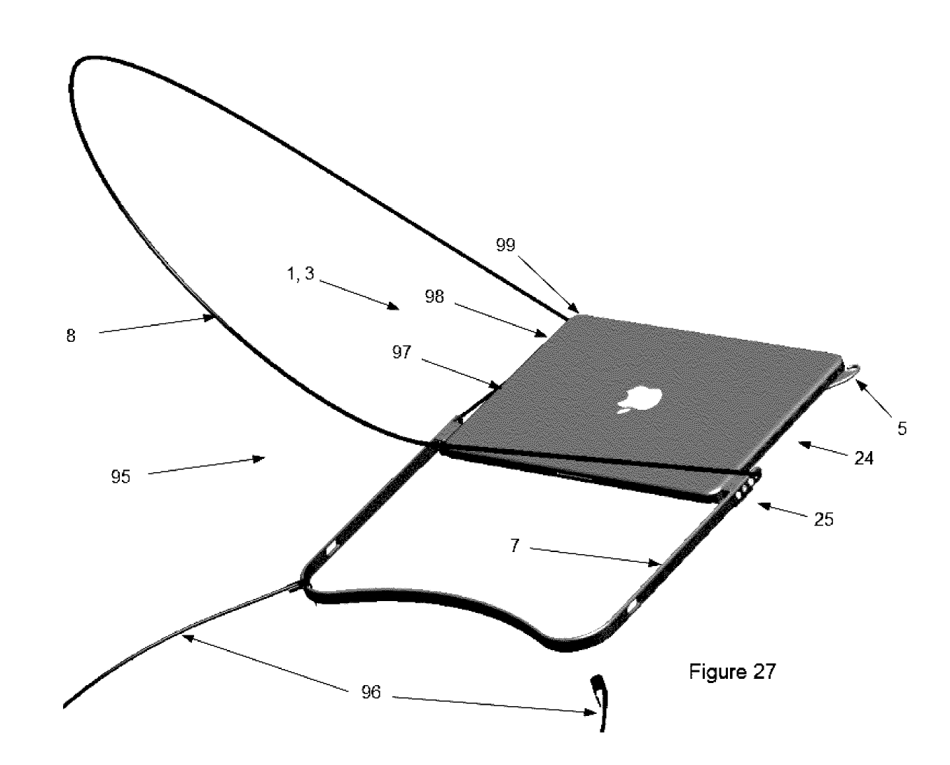

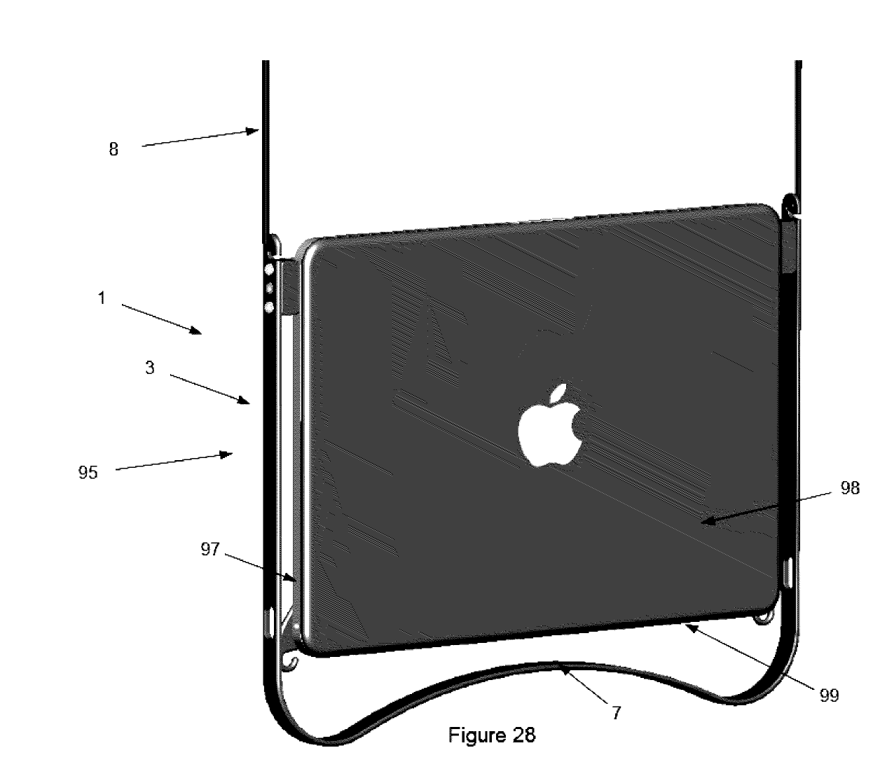

When mobile usage of the laptop-style computer 3 is no longer needed, the user reconfigures it for transport by rotating its display portion 98 about hinge 99 to close it flush against its keyboard portion 97 (see FIG. 27). The user then unhooks neckstrap 8 from its fairlead 5 and rotates swingarm 7 through 180 degrees and locks it into its compact storage configuration (see FIG. 28). The user then lets the closed computer 3 and its reconfigured support 1 swing naturally to their right side for carrying as they would a conventional shoulder bag (see FIG. 28). The decorative cargo panel of FIG. 16 may be affixed to the outer surface of the computer's display portion 98, thereby adding further functionality as a shoulder bag.

The left end 31 of waist strap 96 is shown deployed from its storage position on the user's waist (not shown) and is temporarily affixed with Velcro™ to swingarm 7, thereby fully stabilizing the computer support structure against the user's body while they are engaged in active motion (as previously described in PCT/CA2015/000276 and in PCT/CA2012/000342). The effect of constraining the left side of swingarm 7 is to provide a secure “tensegrity” style of wearing harness for computer 3 that is easily carried and deployed when needed and that provides optimal comfort and ergonomic efficiency while the computer is being used, regardless of whether the user is walking, standing sitting or reclining. As previously noted, the “computer” used in combination with computer support 1 may be a touchscreen “tablet” but might also be a compact “laptop” or “netbook” style of clamshell computer configuration as shown in FIG. 25.

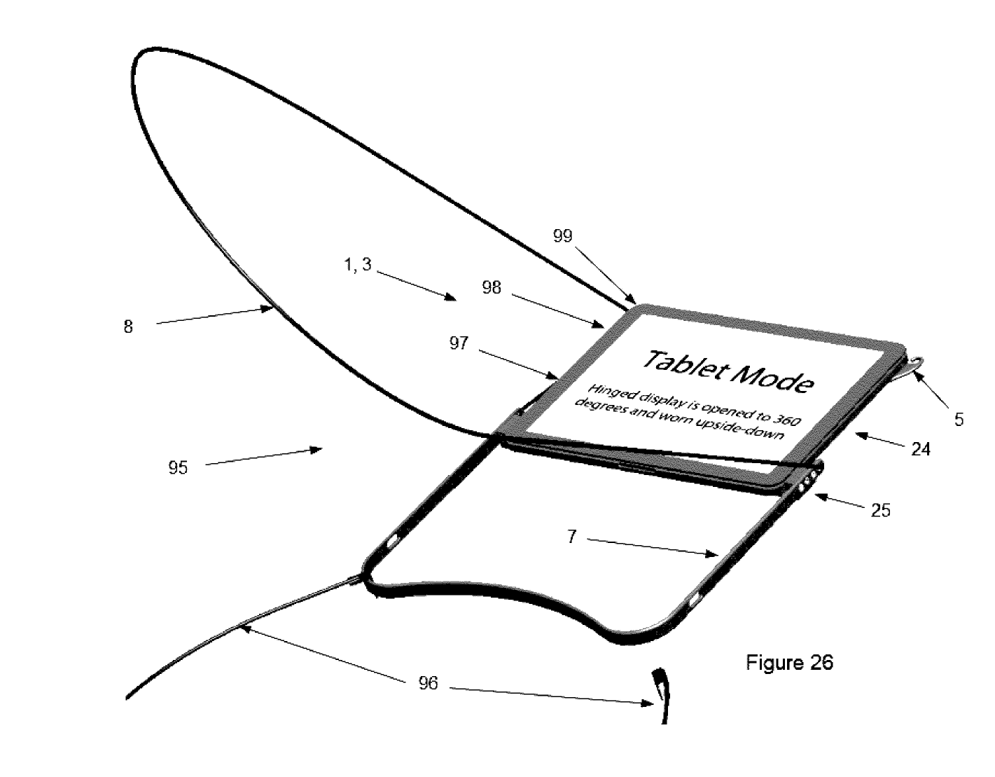

The “laptop-style” of computer shown in FIG. 25 is of the “hybrid” or “dual-mode” style of computer recently popularized by Lenovo's “Yoga™” line of computers. Dual-mode computers can include a 360-degree, multi-axis hinge 99 that enable the touchscreen display portion 98 of the device to be swung through 360 degrees so it folds flush against the back of its keyboard portion 97. If the dual-mode computer's hinge 99 has been appropriately reconfigured and if it is then used in combination with the present invention, then the resulting wearable dual-mode computer 95 can be taken off, flipped over and then worn again with its touchscreen display 98 facing the user, thereby transforming the wearable “laptop” shown in FIG. 25 into the wearable “tablet” shown in FIG. 26.

An alternate methodology for configuring a dual-mode computer is practiced by Microsoft in their “Surface Book™” style of computer. Microsoft do not transform their laptop-style computer into a tablet-style computer by opening and rotating its touchscreen backward through 360 degrees (as practiced by Lenovo). Microsoft's dual-mode transformation is accomplished by the user detaching their touchscreen display portion 97 from hinge 99, rotating it horizontally through 180 degrees, whereupon re-attaching it to the hinge and closing it results in a handheld touchscreen tablet equivalent in functionality to that of a Lenovo's “Yoga-style” dual-mode computer 3. Both general methodologies result in equivalent dual-mode computer functionality and (with suitable modifications) are compatible with the present invention as described below.

The “laptop” and the “tablet” wearing modes of dual-mode computer support 95 each have advantages and disadvantages. The laptop configuration is optimal for mobile typing and for using the device while it is placed on a desktop (not illustrated). However, its hinged touchscreen display 98 limits mobility to some extent and it also precludes its use as a dashboard display (as shown in FIG. 20). The tablet configuration enables the touchscreen to be hung on a dashboard for automotive use; tablet-mode is also somewhat easier to wear and use when mobile.

The laptop-style computer illustrated in FIG. 25 is an Apple MacBook™ and a variety of other compact laptops made by other manufacturers may be used; those include the

“Chromebook™-style” computers which, unlike the MacBook™, have a touchscreen display. Lenovo's “Yoga Book™” or other fully-folding, dual-mode style of computer can also be attached to computer support 1 as shown in FIG. 25 and used in their partially opened “Wearable Laptop” mode as shown. The two-part separable Microsoft Surface Book™ is also appropriate for use with the dual-mode wearable computer support apparatus 95 of FIG. 25. A simple method of configuring the wearable laptop-style of computer shown in FIG. 25 is to use adhesive strips of “3M™ VHB™” adhesive tape to affix the back of any dual-mode computer or laptop-only style computer's keyboard portion 97 to an appropriately configured backplate 24 of computer support 1. Since laptop-style computers must include some form of hinge 99 and such hinges will inevitably display elements of their structure downward as they are opened, suitable notches must be provided in backplate 24 proximate the fairleads 5 (not illustrated) which enable the display portion 98 to open wide enough to permit adequate viewing of it screen while the laptop is being used (approximately 120 degrees).

An effective and relevant means for configuring an equivalent single-mode, laptop-style computer is disclosed by Leong et al in U.S. Pat. No. 9,069,527. Leong's aftermarket conversion accessory has been successfully commercialized under the brand name “Brydge™”; it effectively converts Apple's iPad™ “tablet” into a “laptop” by providing a pair of receiving brackets that are hinged to a keyboard. The device securely grips the handheld tablet and communicates keystroke data to and from the hinged keyboard via a Bluetooth datalink, thereby forming a laptop-style computer similar to that shown in FIG. 25. Like Lenovo's dual-mode “Yoga Book™”, Apple's single-mode “MacBook™” or Microsoft's dual-mode Surface Book™ Leong's tablet-conversion device and matching tablet maybe affixed to computer support 1 to provide a wearable computer with the laptop functionality shown in FIG. 25.

The “Brydge-style” of tablet-to-laptop conversion strategy is cost-effective because it enables millions of existing touchscreen tablet-style computers, such as Apple's iPad™ series or Samsung's Galaxy Tab™ series, to be retro-fitted with laptop functionality. Note however that each tablet make and model requires a custom gripping mean to fit its exact shape and size. Note that tablet-style computers have large radius lower edge fillets to facilitate handholding them and small radius top edge filets to maximize display area; therefore Leong's gripping clips are invariably asymmetrically shaped in order to hold the tablet with its display side facing the user.

Note also that once the handheld tablet is converted into a wearable laptop, it can no longer be used as such when used in combination with the wearable support 1 shown in FIG. 25 (because Leong's single-axis hinge is unable to rotate the display portion 98 through 360 degrees to mate against the back of a keyboard portion 97). This problem is remedied in the present invention by using an extended-reach 360-degree hinge to attach each tablet-gripping bracket to the keyboard portion 98. Alternatively, the asymmetric shape of each single-axis hinged gripping clip is modified so that it can provide both a secure grip onto the cross-sectional shape of the tablet being retro-fitted as well as front-to-back symmetry that allows the tablet to be detached, reversed and reattached facing in the opposite direction, such that enables fully and precisely overlies its corresponding keyboard portion 97 when it is reversed and closed as shown in FIG. 26. To do so, the asymmetric shape of each of its gripper's interior shape is mirror-imaged, thereby enabling the tablet to seat fully while facing in both directions.

While mirror-imaging the shape of the friction grippers will enable Leong's device to serve as a dual-mode computer, the use of friction grippers are poorly suited to the forces imposed by the high-dynamic motion of mobile use of the device and rapid deployment of the swingarm 7. Therefore to further enhance performance of a “receiving case” rather than “gripping pincers” may be employed to hingedly affix the tablet to the keyboard portion 98, which can in turn be affixed to backplate 12 of computer support 1(95). The receiving case is comprised of a close-fitting protective rear shell that grips the perimeter of the tablet to provide a more robust grip suitable for mobile use. The snapped-on receiving case includes a pair of symmetrically located bayonet-style fixtures along its lower edge (not illustrated) that mate with corresponding fixtures on the hinge 99 of keyboard 97. Since front-to-back panel symmetry about hinge 99 is maintained, the direction of converted display portion 98 can be easily and precisely reversed to provide the two desired dual-mode computer configurations shown in FIG. 25 and FIG. 26. Another edge-mating strategy between the tablet's receiving case and hinge 99 is to provide symmetric male/female edge extrusions that enable the detachable display portion 98 to slide into the hinge 99 from the side with its touchscreen surface correctly positioned and facing in either direction (also not illustrated).

A serendipitous advantage of converting a tablet-style computer to form the display portion 98 of computer 3 is that, unlike most laptop-style computers, tablet-style computers typically include a high-quality camera on their rear surface (see 3A in FIG. 9) that will point advantageously while being worn as shown in FIG. 25. The hingedly affixed tablet's camera configuration provides the user with a wearable camera without the need to mount a hinged external camera as shown in FIG. 1.

Various multi-axis 360-degree hinges exist that provide suitable friction characteristics and closing geometry for configuring a dual-mode computer for use with the present invention. Lenovo have devised a variety of hinge configurations that enable dual-mode usage (see U.S. Pat. No. 8,958,206, U.S. Pat. No. 8,687,354, US20150259959, US20150277506, U.S. Pat. No. 8,861,187, U.S. Pat. No. 9,009,919, US20110265288 and US20090070961). Nokia also has relevant prior art (US US20070164924, U.S. Pat. No. 5,915,440 and others). Other “living hinge” style of flexible hinges made of fabric or laser-cut metal are adaptable to rotatably mounting display portion 98 to keyboard portion 97 such that the two faces of each panel can be swung through 360 degrees. Angular position must be maintained throughout the display panel's rotational travel and high-friction multi-axis hinges are commonly available for single axis use in laptop displays. Using two pairs of these high-friction hinges with suitable inter-axis distances will provide a suitable hinge 99 for actuating display portion 98 with respect to keyboard portion 97 in the dual-mode computer embodiment 95 of the present invention. Since the present invention will be actively used and carried about in more active work environments than typical laptops, the closing friction of hinge 99 may be augmented by means of a positive latching mechanism that prevents inadvertent opening (not illustrated).

If a user mounts a Lenovo-style of dual-mode computer 3 onto backplate 12 for wearability and then attempts to rotate the touchscreen display portion 98 through 360 degrees so that it mates flush against the back of its keyboard portion 97, the thickness of backplate 12 shown in FIG. 25 will jam the operation either at 180 degrees in the case of the current Brydge-style of tablet to laptop conversion (due to its single-axis hinge construction) or else somewhat closer to 360 in the case of the Lenovo-style of 360 degree hinge (due to the thickness of backplate 24 preventing full hinge closure). In both cases the laptop-style computer is prevented from being fully folded to form a tablet-style computer. For example, that rotational constraint problem prevents Lenovo's Yoga Book™ from fully converting from its “laptop” mode into its “tablet” mode and thereby precludes its ability to fully fold into its tablet-mode when mounted onto wearable computer support 1. If however Lenovo's hinge 99 were appropriately re-configured to reach around the added thickness of backplate 24, the user would become able to wear their Yoga™ computer in both modes.

Therefore, in a preferred embodiment, the computer support 1 is used in combination with a folding dual-mode computer in which its multi-axis hinge elements have been configured to accommodate the thickness of backplate 24, thereby allowing touchscreen display portion to arrive flush against backplate 12 when fully rotated. The resulting new style of wearable computer 95 enables its user to selectively enjoy the benefits of both a laptop and a tablet style of computers while mobile. In another preferred embodiment, a handheld tablet such as Apple's iPad is gripped by clips hinged to a keyboard portion. The tablet-to-hinge gripping clips are symmetrically configured (not illustrated) such that the tablet can be removed and reinstalled in the opposite direction, thereby enabling the device to be mounted and used in combination with computer support 1 to form a wearable dual-mode computer 95.

An alternate strategy to achieve the same result is to incorporate the functional elements of backplate 12 (fairleads 5 and locking swingarm mounts 25) into the housing of keyboard portion 97 (not illustrated). This “OEM” embodiment requires more substantial redesign of a dual-mode computer or to a specific tablet-to-laptop retro-fitted keyboard adaptor however once tooling is complete it would reduce production costs.

Note that the Apple MacBook™ modeled in FIG. 25 requires that cable access slots be provided through the swingarm in order to enable its USB-C and headphone cables to be plugged-in while the swingarm is closed for desktop use. A similar problem exists with Lenovo's YogaBook™ dual-mode computer. Therefore, to further optimize the purpose-built version of the hybrid computer 3 and its computer support 95, the computer's communication ports and control buttons are located along its front or rear edges rather that the sides, thereby insuring easy access to them, regardless of the swingarm's position.

FIG. 26 illustrates the embodiment of FIG. 25 with the computer configured as a tablet and the computer support is worn upside-down with respect to FIG. 25. Multi-axis hinge 99 has enabled display portion 98 of dual-mode computer 3 to be rotated through 360 degree to form a tablet-style computer with keyboard portion 97 underneath. In order to utilize this new configuration, the user has removed neckstrap 8 from over their head and inverted the device before wearing it again with its touchscreen held for hands free use. Alternatively, if the dual-mode computer 3 is one that converts between modes by detaching its display portion 98 from its hinge 99 and reattaching it facing in the opposite direction, the user can continue wearing the computer support 95 and simply rotate the reversed display portion onto keyboard portion 97 to form the tablet-style computer depicted in FIG. 26.

FIG. 27 illustrates the embodiment of FIG. 25 with the display portion 98 of computer 3 closed onto keyboard portion 97, thereby configuring it for transport.

FIG. 28 illustrates the embodiment of FIG. 25 with both the computer and the wearable computer support configured for transport. Swingarm 7 has been rotated to its compact storage configuration around computer 3 so that the user may use neckstrap 8 as a sling to carry it about like a shoulderbag.

Note that when a mobile user carrying their folded dual-mode wishes to use computer 3 for brief periods of handheld use, they will leave swingarm locked in its compact storage position and grasp in one hand while opening display panel 98 with the other. As the display panel is swung open, its rotation will inevitably be stopped when it contacts the nearby curved portion of the swingarm 7. For best ergonomic performance, users will want to open the display as far as possible and also avoid damaging the back of the display panel. Therefore, the swingarm can have an appropriately angled straight bevel is cut-out along its closest inside curve (not illustrated), thereby providing a flat arresting surface for the back of the display panel.

To help provide a wide opening angle for display panel 98, the sidearms of swingarm 7 may be extended somewhat, thereby increasing its contact distance. To further protect the panel 98 from being marred from repeated contacts against swingarm 7, its contact area may be protected by a patch of clear protective film such as 3M's Scotchguard paint protection film™ (not illustrated).

The appearance and functionality of the shoulderbag configuration of FIG. 28 can be enhanced by attaching the “decorative cargo panel” shown as 70 in FIG. 15 to FIG. 19. To prepare the back of display panel 98 for affixing decorative cargo panel 70, suitably located patches of Velcro™ hook material (not illustrated) are adhesively affixed to panel 98 (or to its tablet-gripping shell if present). If so configured, the attachment points are located far enough away from swingarm 7 that, as display panel 98 is rotated open about hinge 99, the flexible cargo panel 70 can deform like a skirt to ride over the nearby portion of swingarm 7 and thereby maintain its functionality.

In some work scenarios, users may wish to configure their dual-mode computer into its compact tablet configuration of FIG. 26 and carry it that way for repeated fast access to the display. In such cases, the touchscreen display side of display panel 98 will be carried facing outward instead of its back side as shown in FIG. 28. FIG. 15 illustrates how that tablet-mode only carrying scenario looks when a screen cover 76 is provided by hinging it to a tablet receiving case 4. To provide the same protective function and to also provide a base for attaching a decorative cargo panel 70 to the dual-mode computer configured in its tablet mode, a similar hinged screen cover accessory may be provided (not illustrated). Detachable screen cover accessories may be provided that affix either onto the receiving case of a “Brydge-style” of converted dual-mode computer or onto the swingarm's locking left and right pivot-locking mechanisms. Suitable fixation hooks, clips or magnetic mounts (not illustrated) will be apparent to those practiced in the art.

### CONCLUSION

The foregoing has constituted a description of specific embodiments showing how the invention may be applied and put into use. These embodiments are only exemplary. The invention in its broadest, and more specific aspects, is further described and defined in the claims which now follow. These claims, and the language used therein, are to be understood in terms of the variants of the invention which have been described. They are not to be restricted to such variants, but are to be read as covering the full scope of the invention as is implicit within the invention and the disclosure that has been provided herein.

1. A portable computer support in combination with a camera mount carried by the computer support for connecting to and supporting a camera in a constrained geometric relationship with respect to a portable computer when such a computer is positioned within the computer support wherein the camera mount is in the form of a camera support connector which is positioned on the computer support along the outer edge of the computer support remote from the body of a user.

2. The computer support of claim 1 wherein the support for carrying the weight of the computer comprises:
a) an upper body support member in the form of a shoulder strap or cords by which the weight of the computer may be carried by the upper body of the user, and
b) a body propping member for positioning the computer outwardly from the torso of the user.

3. The combination as in claim 2 wherein the outer corners of the computer support are provided with fairlead guides to receive the upper body support cords when the computer support is deployed, the fairleads being in the form of protruding hooks or notches and serving as guides for the camera support connector.

4. The combination as in claim 3 wherein the camera support connector is a multi-part assembly, one part of the assembly being a receiving guide which is attached to a fairlead and the other part of the assembly being adapted for connection to a camera, the respective parts of the assembly being disengageably engageable with each other.

5. The combination of claim 4 wherein the camera support connector has an upper portion serving as a seat for receiving a camera or a fitting carrying a camera and a lower clamping bolt screwed into the seat through the hook, the seat of the upper portion of the camera support connector comprising a bevelled top-ledge carrying a stud that is dimensioned to engage with a camera or component connected to the camera.

6. The combination as in claim 1 wherein the camera support connector is articulated about a joint to allow adjusting the pointing direction of the camera to range about at least a single axis.

7. The computer support of claim 1 in combination a portable computer with a viewing screen comprising a stereoscopic viewer connected to the computer or body support to permit stereoscopic viewing by a user of an image on the screen of the computer wherein the body-support is adjustably positionable between a deployed position in front of a user for manual access to the screen, and a viewing position, wherein the computer screen is held in close proximity to the face of a user for stereoscopic viewing.

8. The computer support claim 7 wherein the body support for the computer includes straps by which the computer may be supported by the upper torso of a user, the straps being adjustable in their length to permit the computer to be located at a deployed position in front of a user providing manual access to the screen, and a viewing position, wherein the computer screen is held in close proximity to the face of a user.

9. The computer support claim 8 wherein the stereoscopic viewer comprises:
i) respective left and right lenses for viewing the stereoscopic image close-up to a user's face,
ii) a frame for holding such lenses, and
iii) a mount extending from the frame for connecting to the computer support, or a computer when present.

10. The computer support of claim 1 in further combination with a sheet of light-cloaking fabric adapted and dimensioned to be affixed over the user's head along its upper portion, and to be draped forward over the computer support and stereoscopic viewer when present comprising:
1) a sheet of lightweight, opaque, light-cloaking fabric dimensioned to be draped forward from a user's head to hang past the edges of computer deployed before the user;
2) a hat with provision for the fabric to be rolled-up to the edge of the hat for storage.

11. A portable computer support comprising:
a) an upper body support member in the form of the neck or shoulder strap or cord by which the weight of the computer may be carried by the upper body of the user,
b) a body propping member for positioning the computer outwardly from the torso of the user in a deployed position co-planar with the computer when present, the body propping member including two movable arms with computer connections for connecting with the computer support or computer and outer deployable arm ends that are joined by a bridge to form a U-shaped propping member or “swingarm”,
c) a disengageable latch at the computer connection on at least one of such arms which allows such arm to be disengageably fixable at the deployed position to allow locking of the U-shaped propping member in place, and
d) a disengageable latch at the computer connection on at least one of such arms which allows such arm to be disengageably fixable at right angles to the computer when present,
in combination with automobile dashboard mounting fixtures fastened to the upper surface of the dashboard of an automobile and positioned on the dashboard for engagement with the extended swingarm of the computer support when placed in the right angle position.

12. The combination as in claim 11 in further combination with cushion patches mounted on the dash to receive and cushion the lower corners of the computer support.

13. A portable computer support comprising:
1) an upper body support member in the form of the neck or shoulder strap or cord by which the weight of the computer may be carried by the upper body of the user,
2) a body propping member for positioning the computer outwardly from the torso of the user in a deployed position co-planar with the computer when present, the body propping member including two movable arms with a computer-supporting backplate positioned there between, and having computer connections for connecting with the backplate or computer when present, and outer deployable arm ends that are joined by a bridge to form a U-shaped propping member or “swingarm”,
in combination with a laptop-style computer of dual-mode format having a keyboard panel and a screen panel wherein the two panels are hingedly configurable between a first configuration wherein both panels are accessible, respectively, for typing and viewing, and a second configuration wherein the screen panel overlies the keyboard panel exposing the screen panel for access as a tablet computer.

14. The portable computer support of claim 13 wherein the keyboard panel is hinged to the screen panel by a hinge that permits the screen panel to be swung through 360 degrees for positioning beneath the keyboard panel wherein the hinge provides a gap when the screen panel is positioned to underlie the keyboard panel with the backplate of the computer support located therebetween.

15. The portable computer support of claim 14 wherein the keyboard panel includes neckstrap cord fairleads proximate the corners that are furthest from the user and body-propping member mounts proximate the corners that are closest to the user.

16. The portable computer support of claim 14 wherein the screen panel is comprised of a touchscreen tablet computer such as an iPad™.

17. The portable computer support of claim 16 wherein the screen panel is detachably hinged to the keyboard panel and reattachable facing in opposite directions.

18. The portable computer support of claim 13 in combination with a detachable decorative cargo panel having an outer perimeter and shape that:
1) conforms approximately to the outer contours of the computer support, thereby concealing the computer and computer support while being shoulder-carried by a user;
2) has an inner elastomeric foam-core to which is bonded two outer layers of “UBL™” or “Velcro™ Loop” fabric on both sides for engaging with Velcro™ hook fasteners carried on the computer support.

19. A cargo panel as in claim 18 wherein at least one of the outer layers is made of white polyester that enables digital images to be printed thereon.

20. A cargo panel as in claim 18 combined with a cargo module provided with Velcro™ hook fasteners to be affixed to the outer surface of the cargo panel, thereby enabling the user to carry sundry items in the cargo module.
